(19) United States
(12) Patent Application Publication
(10) Pub. No.: US 2017/0228745 A1
(43) Pub. Date: Aug. 10, 2017

(54) TOOLS AND METHODS FOR CAPTURING AND MEASURING HUMAN PERCEPTION AND FEELINGS

(71) Applicant: UEGroup Incorporated, San Jose, CA (US)

(72) Inventors: Sarah Garcia, San Jose, CA (US); Laura Hammond, San Jose, CA (US); Anna Soederstroem, Morgan Hill, CA (US); Antonio Fernandes, San Jose, CA (US); Paul Fernandes, Pleasanton, CA (US); Kimberly Blair Koeneman, St. Louis, MO (US); Norene Bylski Kelly, Johnston, IA (US)

(21) Appl. No.: 15/428,001

(22) Filed: Feb. 8, 2017

Related U.S. Application Data
(60) Provisional application No. 62/293,264, filed on Feb. 9, 2016.

(51) Int. Cl. G06Q 30/02

(52) U.S. Cl. CPC G06Q 30/0203

(57) ABSTRACT

Provided herein are systems and methods for a perception and feeling tool having multiple modules configured to allow participants to express perceptions and feelings at one or more moments during, for example, a study. The perception and feeling tool can be configured to record the participants' perceptions and feelings at the one or more moments during the study as collected data, as well as display results for any one or more of the participants or an aggregate of all the participants for the perceptions and the feelings at the one or more moments. A collection module can be configured to collect raw data including the participants' perceptions and feelings. One or more analytical modules can be configured to apply analytics to the raw data. One or more servers can be configured to deliver user interfaces to the participants and allow the participants to express the study.

### CROSS-REFERENCE

This application claims priority to U.S. Provisional Patent Application No. 62/293,264, filed Feb. 9, 2016, titled “TOOLS AND METHODS FOR CAPTURING AND MEASURING HUMAN PERCEPTION AND FEELINGS,” the disclosure of which is hereby incorporated herein by reference in its entirety.

### NOTICE OF COPYRIGHT

A portion of the disclosure of this patent document contains material that is subject to copyright protection. The copyright owner has no objection to the facsimile reproduction by anyone of the software engine and its modules, as it appears in the Patent and Trademark Office Patent file or records, but otherwise reserves all copyright rights whatsoever.

### FIELD

The design generally relates to systems and methods for capturing accurate emotional responses from users of products and services.

### BACKGROUND

Usability testing can be used to evaluate an existing or early-stage product or service by testing usability of the product or service on users for direct user input. Examples of products and services that can benefit from usability testing include local software applications, web applications, web sites and services provided therethrough, computer interfaces, consumer products, documents such as instructions for use of the consumer products, and the like. Identifying and correcting usability problems up front with usability testing can reduce costs of modifying software, modifying web sites and services provided therethrough, remanufacturing consumer products, updating documents, and the like. To date, there is a lack of a means for capturing accurate emotional responses from users in, for example, usability testing for identifying and correcting usability problems. Provided herein are systems and methods that address the foregoing.

### SUMMARY

Provided herein are systems and methods for a perception and feeling tool having multiple modules configured to allow participants to express perceptions and feelings at one or more moments during a study, for example, a usability-testing study. The perception and feeling tool can be further configured to record the participants' perceptions and feelings at the one or more moments during the study as collected data. A researcher can also interact with perception and feeling tool in various ways. For example, the perception and feeling tool can be further configured to display results for the researcher for any one or more of the participants or an aggregate of all the participants for the perceptions and the feelings at the one or more moments during the study. A collection module can be configured to collect raw data including the participants' perceptions and feelings. One or more analytical modules can be configured to apply analytics to the raw data collected by the collection module. One or more servers or other computing devices can be configured to deliver user interfaces to the participants in the study and allow the participants to express the perceptions and the feelings at the one or more moments during the study.

In an embodiment, the perception and feeling reporting tool can be built and configured to use a combination of modules to allow participants to better express how they were feeling at a given moment during a study (e.g., usability-testing study) and apply analytics to the collected data. The perception and feeling reporting tool can also be constructed with a number of software modules cooperating with each other. The perception and feeling reporting tool can be built and configured to provide numerous features discussed herein.

### DRAWINGS

The multiple drawings refer to example embodiments of the design, in which:

FIG. 1 provides web-site images including services provided therethrough as selected by a researcher corresponding to usability-testing moments in accordance with some embodiments;

FIG. 2A provides a general flow through a perception and feeling reporting tool in accordance with some embodiments;

FIG. 2B provides a flow for a participant to self-report his or her perception or feeling based on questions presented by a perception and feeling tool in accordance with some embodiments;

FIG. 3A provides a digitized chart configured to enable a participant to self-report his or her perceptions or feelings during one or more moments in accordance with some embodiments;

FIG. 3B provides a digitized chart configured to enable a participant to self-report his or her perceptions or feelings during one or more moments in accordance with some embodiments;

FIG. 3C provides a digitized chart similar to that of FIG. 3A or FIG. 3B including an overlay of numerical values for emotional strengths for coordinates of the digitized chart in accordance with some embodiments;

FIG. 4 provides a slider configured to enable a participant to self-report his or her perceptions or feelings instead of a digital chart during one or more moments in accordance with some embodiments;

FIG. 5A provides an interface configured to enable a participant to self-report his or her perceptions or feelings from pre-selected emotions during one or more moments in accordance with some embodiments;

FIG. 5B provides an interface configured to enable a participant to self-report his or her perceptions or feelings during one or more moments in accordance with some embodiments;

FIG. 6A provides an interface configured to enable a researcher to review a participant's perceptions or feelings during one or more moments in accordance with some embodiments;

FIG. 6B provides an interface configured to enable a researcher to review a participant's perceptions or feelings during one or more moments in accordance with some embodiments;

FIG. 6C provides an interface configured to enable a researcher to review a group of participants and their perceptions or feelings during one or more moments in accordance with some embodiments;

FIG. 6D provides an interface configured to enable a researcher to review a group of participants and their perceptions or feelings during one or more moments in accordance with some embodiments;

FIG. 6E provides an interface configured to enable a researcher to review a group of participants and their perceptions or feelings during one or more moments in accordance with some embodiments;

FIG. 7A provides an interface configured to enable a researcher to sign up for an account on one or more servers or log in to an existing account on the one or more servers in accordance with some embodiments;

FIG. 7B provides an interface configured to enable a researcher to create a new study and edit any of a number of existing studies in accordance with some embodiments;

FIG. 7C provides an interface configured to enable a researcher to edit a study in accordance with some embodiments;

FIG. 7D provides an interface configured to enable a researcher to edit a study in accordance with some embodiments;

FIG. 7E provides an interface configured to enable a researcher to start a study in accordance with some embodiments;

FIG. 7F provides an interface configured to enable a researcher to add participants to a study in accordance with some embodiments;

FIG. 7G provides an interface configured to enable a researcher to review moments or questions in a study along with participants and results for the study in accordance with some embodiments;

FIG. 7H provides an interface configured to enable a researcher to view results for a study in accordance with some embodiments;

FIG. 8 illustrates a block diagram of an example computing system that can be used with one or more of the servers and client devices in accordance with some embodiments; and

FIG. 9 illustrates a block diagram of an example network that can be used with the one or more of the servers and client devices in accordance with some embodiments.

While the design is subject to various modifications and alternative forms, specific embodiments thereof have been shown by way of example in the drawings and will herein be described in detail. The design should be understood to not be limited to the particular forms disclosed, but on the contrary, the intention is to cover all modifications, equivalents, and alternatives falling within the spirit and scope of the design.

### DESCRIPTION

In the following description, numerous specific details are set forth, such as examples of specific perception and feeling reporting services, named components, connections, number of databases, etc., in order to provide a thorough understanding of the present design. It will be apparent; however, to one skilled in the art that the present design can be practiced without these specific details. In other instances, well known components or methods have not been described in detail but rather in a block diagram in order to avoid unnecessarily obscuring the present design. Thus, the specific details set forth are merely exemplary. The specific details discussed in one embodiment can be reasonably implemented in another embodiment. The specific details can be varied from and still be contemplated to be within the spirit and scope of the present design.

Usability testing can be used to evaluate an existing or early-stage product or service by testing usability of the product or service on users for direct user input. Examples of products and services that can benefit from usability testing include local software applications, web applications, web sites and services provided therethrough, computer interfaces, consumer products, documents such as instructions for use of the consumer products, and the like. Identifying and correcting usability problems up front with usability testing can reduce costs of modifying software, modifying web sites and services provided therethrough, remanufacturing consumer products, updating documents, and the like. To date, there is a lack of a means for capturing accurate emotional responses from users in, for example, usability testing for identifying and correcting usability problems. Provided herein are systems and methods that address the foregoing.

For example, provided herein in some embodiments are systems and methods for a perception and feeling tool having multiple modules configured to allow participants to express perceptions and feelings at one or more moments during a study, for example, but not limited to, a usability-testing study. The perception and feeling tool can be further configured to record the participants' perceptions and feelings at the one or more moments during the study as collected data. A researcher can also interact with the perception and feeling tool in various ways. For example, the perception and feeling tool can be further configured to display results for the researcher for any one or more of the participants or an aggregate of all the participants for the perceptions and the feelings at the one or more moments during the study. The perception and feeling tool can be further configured to display results for any one or more of the participants or an aggregate of all the participants for the perceptions and the feelings at the one or more moments during the study. A collection module can be configured to collect raw data including the participants' perceptions and feelings. One or more analytical modules can be configured to apply analytics to the raw data collected by the collection module. One or more servers or other computing devices can be configured to deliver user interfaces to the participants in the study and allow the participants to express the perceptions and the feelings at the one or more moments during the study.

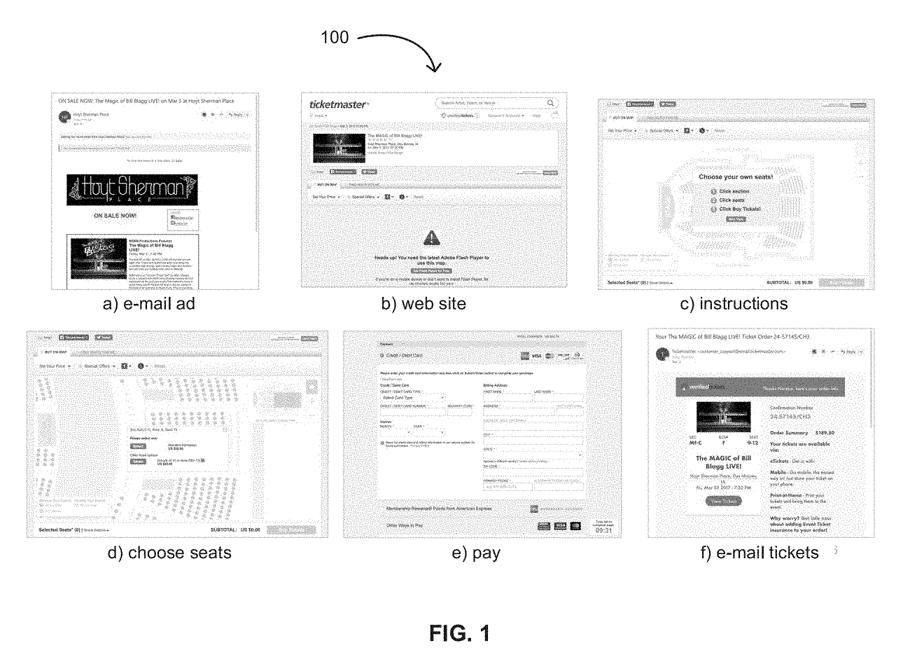

Examples of products and services that can benefit from usability testing include, but are not limited to, local software applications, web applications, web sites and services provided therethrough, computer interfaces, consumer products, documents such as instructions for use of the consumer products, and the like. Usability-testing studies for any of the foregoing can include usability testing at one or more so-called moments. For example, a usability-testing study for a ticket-vending web site and services provided therethrough can, as shown in FIG. 1, include usability testing at one or more so-called moments 100 including a) receipt of an e-mail with an advertisement for a particular event therein; b) a web-based visit to an on-line ticket vendor by clicking through the e-mail advertisement; c) receipt of instructions for finding a seat for the particular event in a particular venue; d) a graphical means for choosing one or more seats in the particular venue; e) paying for tickets for the one or more seats in a payment-processing user interface; and f) receipt of the tickets for the particular event via e-mail. Using systems and methods provided herein, a researcher can select any one or more moments for participants in a study such as, but not limited to, the foregoing moments a)-f) for the participants in the usability-testing study for the ticket-vending web sites and services provided therethrough.

Again, systems and methods provided herein are not limited to such usability testing. For example, systems and methods provided herein can simply prompt a participant a number of times per day in everyday life to track and quantify emotion for a variety of other purposes than usability testing. For example, instead of the moments being selected and provided by a researcher, the moments could be intervallic such as once every day or once every 3 hours (e.g., 9:00 AM, noon, 3 PM, etc.), and the participant could be prompted to describe the perceptions and feelings he or she is experiencing at those moments. Medicine including mental health services and pharmaceutical testing/clinical trials can benefit from such tracking and quantification of emotions. Such tracking and quantification might be considered a diary study in some embodiments.

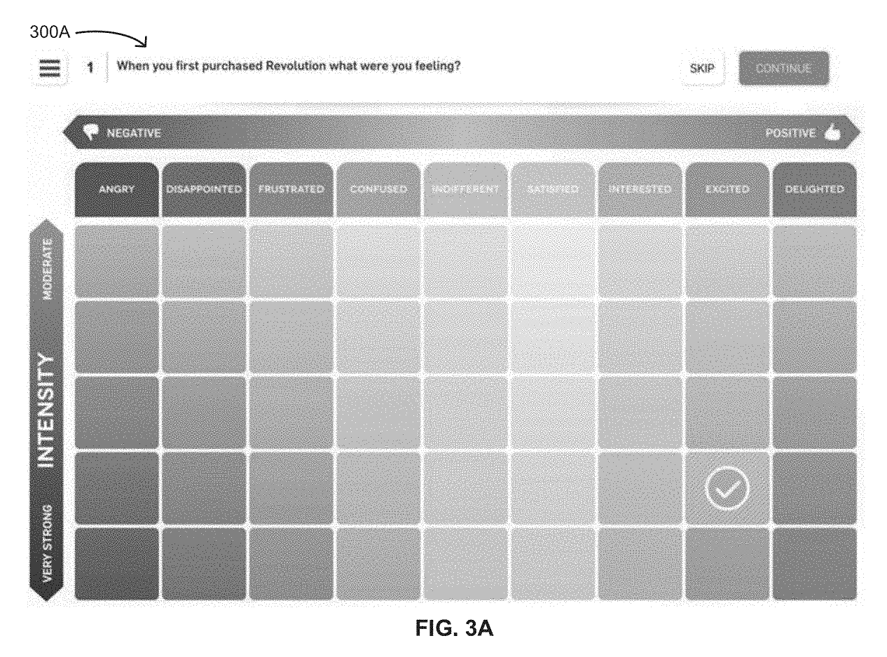

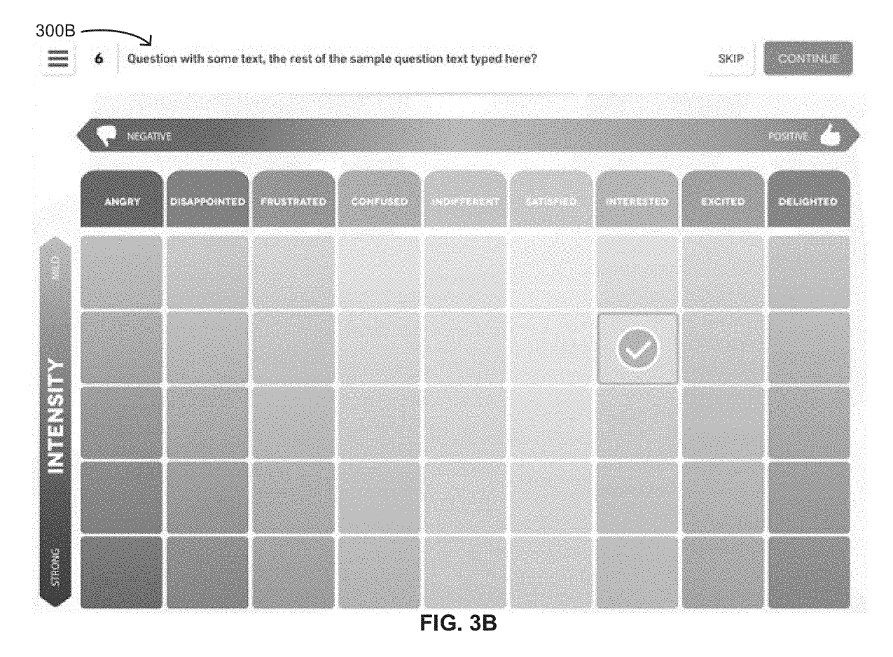

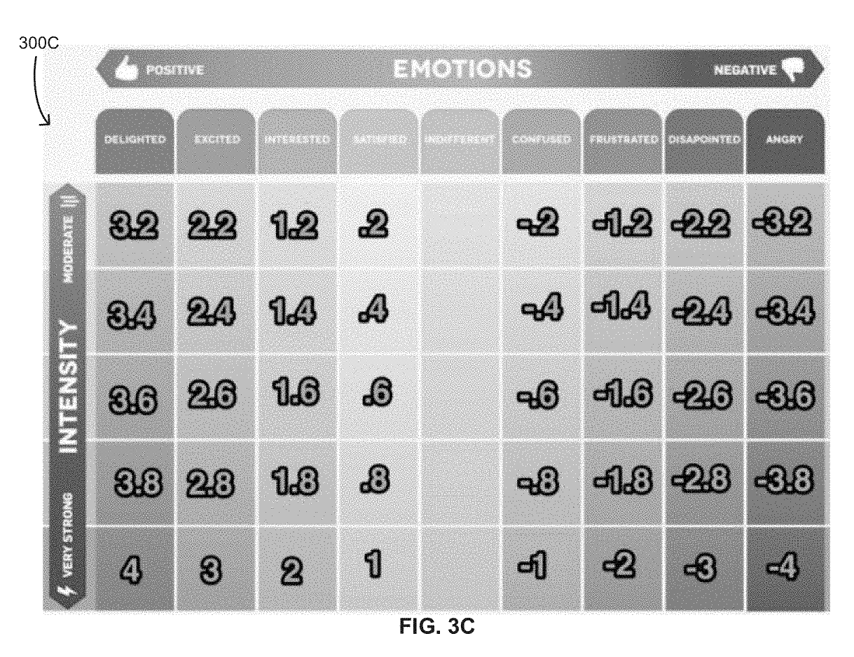

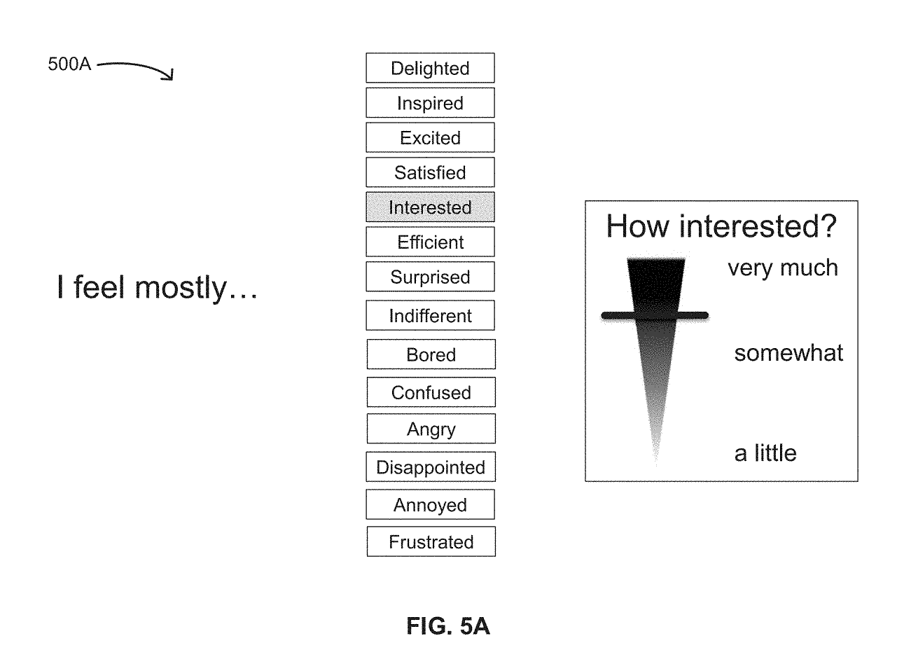

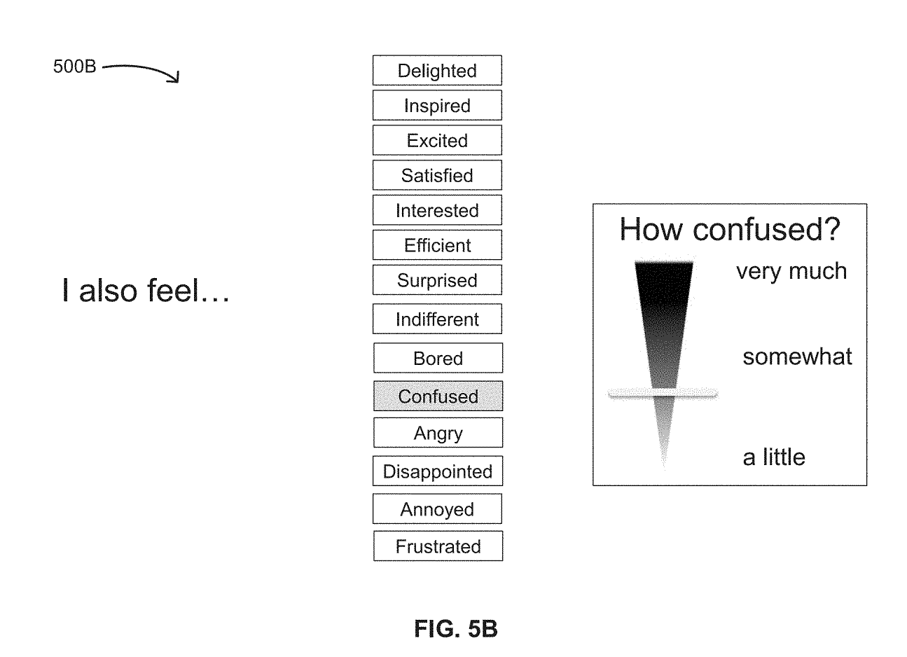

In general, the perception and feeling reporting tool can be configured to digitize a chart such as digitized chart 300A in FIG. 3A or digitized chart 300B in FIG. 3B or another interface such as interface 500A in FIG. 5A or interface 500B of FIG. 5B to allow participants to better express how they were feeling at a given moment during a study (e.g., usability-testing study) and record the participant's feelings at multiple discreet points during the study. The perception and feeling reporting tool can also be built and configured to use a combination of modules to allow participants to better express how they were feeling at a given moment during a study and apply analytics to the collected data to produce unique output/visualizations. The perception and feeling reporting tool can be built and configured as a Software as a Service tool that allows researchers to track the self-reported perception and feelings states of a person (e.g., a study participant) through an experience.

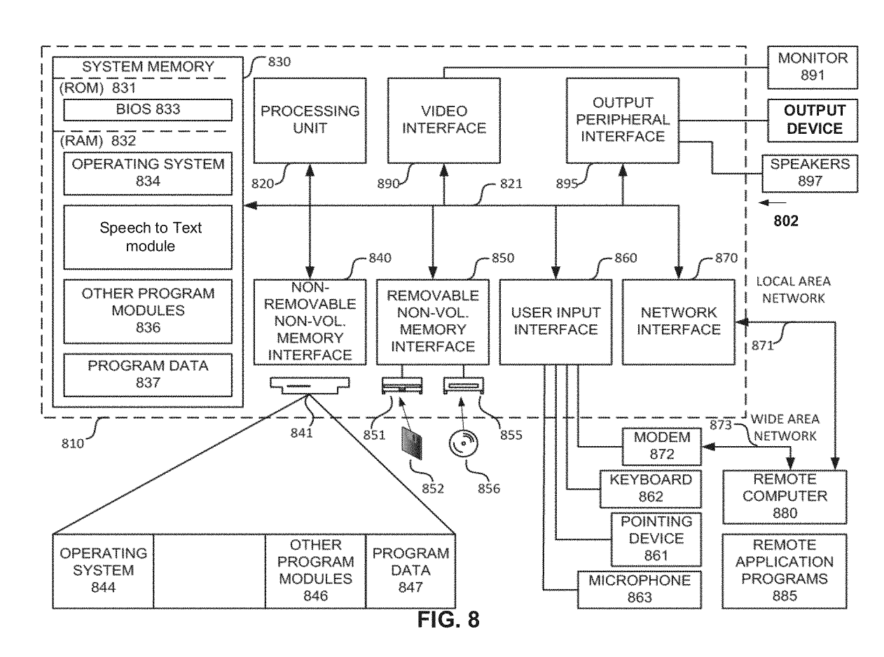

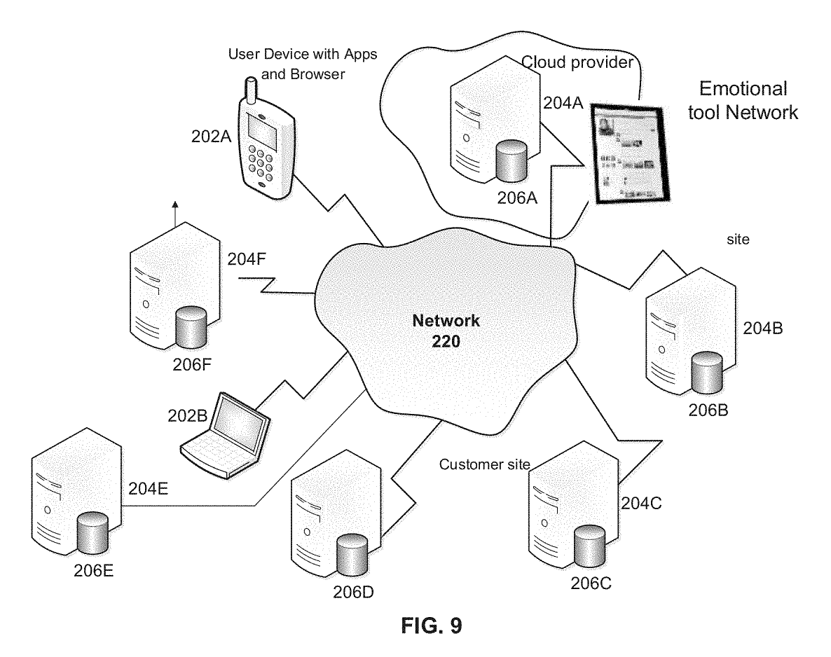

Example processes for and apparatuses to provide the perception and feeling reporting tool are described. The following drawings and text describe various example implementations of the design. FIG. 8 and FIG. 9 illustrate example environments to implement the concepts.

The perception and feeling reporting tools can use one or more servers or other computing devices to deliver user interfaces to participants in a study on a client device. The perception and feeling reporting tools can be implemented on a tablet computing device. A server can be backed by a database that can cooperate with one or more client computing devices such as the tablet to store questions and participant responses during the study.

The perception and feeling reporting tool can also be built and configured to use a combination of modules to allow participants to better express how they were feeling at a given moment during a study and apply analytics to the collected data. The perception and feeling reporting tool can be constructed with a number of software modules cooperating with each other.

In an embodiment, the perception and feeling reporting tool can be customized to measure and record the emotional feelings of one or more participants in a study. A first module can be configured to solicit and obtain each participant for the study by presenting a series of user interfaces. A second module of the perception and feeling reporting tool can be configured to digitize a chart or similar diagram to allow participants to better express feelings at a given moment during a study and record the participants' feelings at multiple discreet points during the study. The perception and feeling reporting tool can be built and configured as a Software as a Service tool that allows researchers to track the self-reported emotional states of a person through an experience. Some of the user interfaces can be configured to present questions, topics, images, or videos at a point in a study, and then a second user interface can be configured to present a numeric value-based digital plot of possible emotions for the participant to express and record their feelings/emotions at that point in the study. A third software module can be configured to collect the feelings/emotions expressed and recorded by the participants, as well as apply analytical algorithms to do various functions, such as aggregates, on those recorded responses for all of the participants. The third software module can be further configured to apply linear or weighted algorithms to determine how a group of participants were feeling at a given moment during a study.

A general flow 200A through the perception and feeling reporting tool can be as follows:

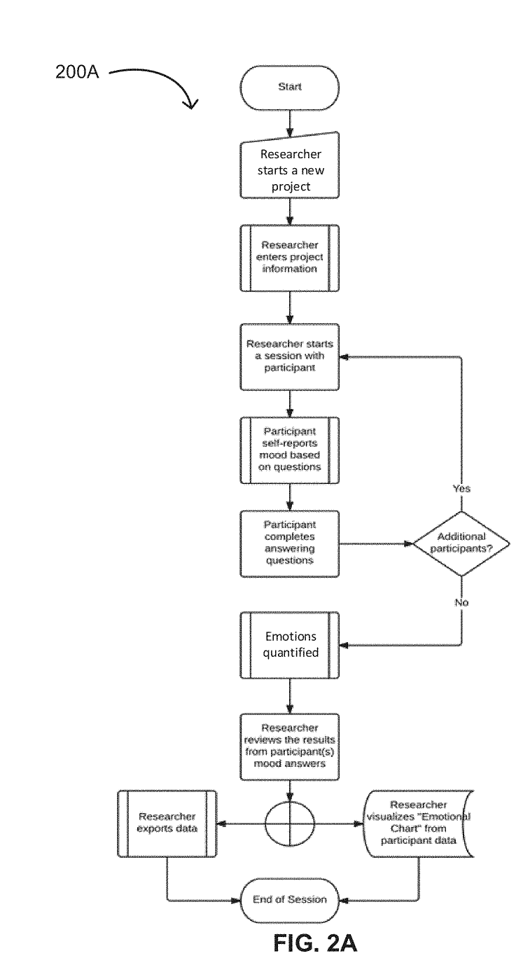

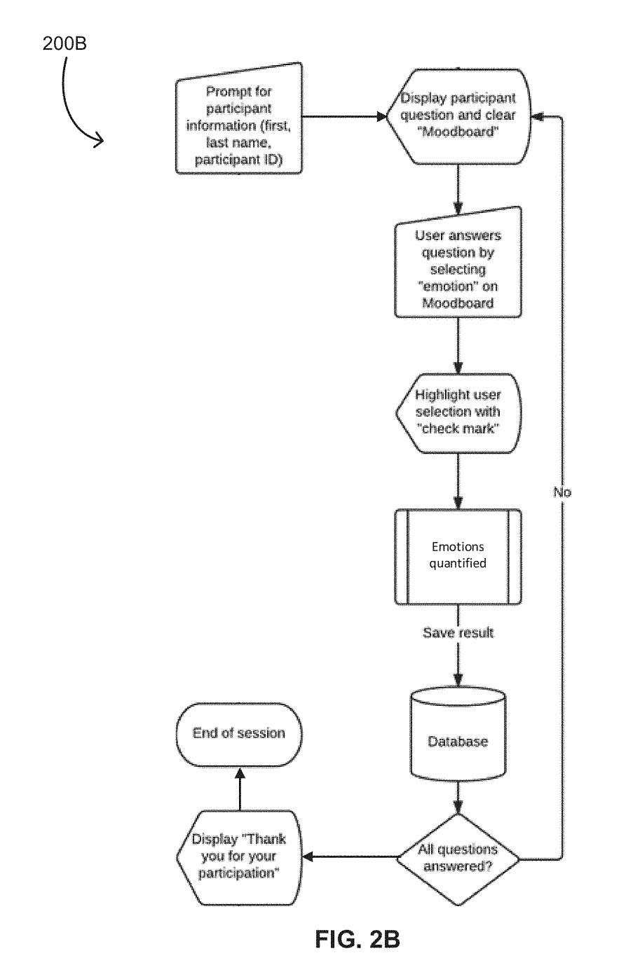

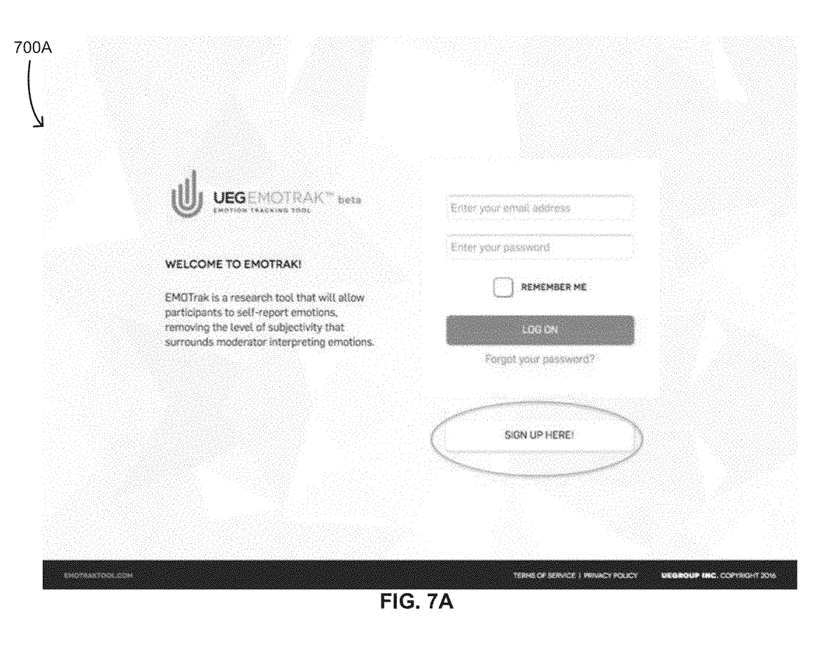

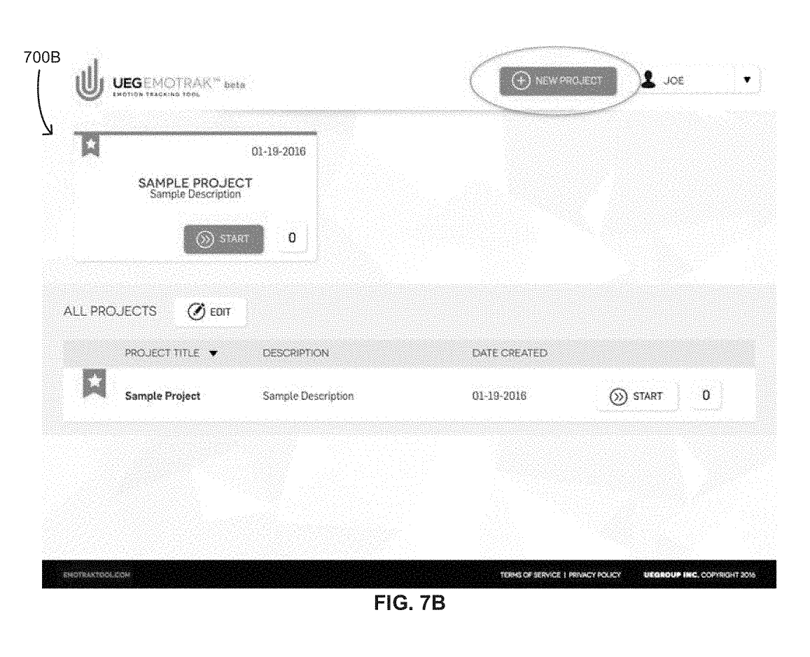

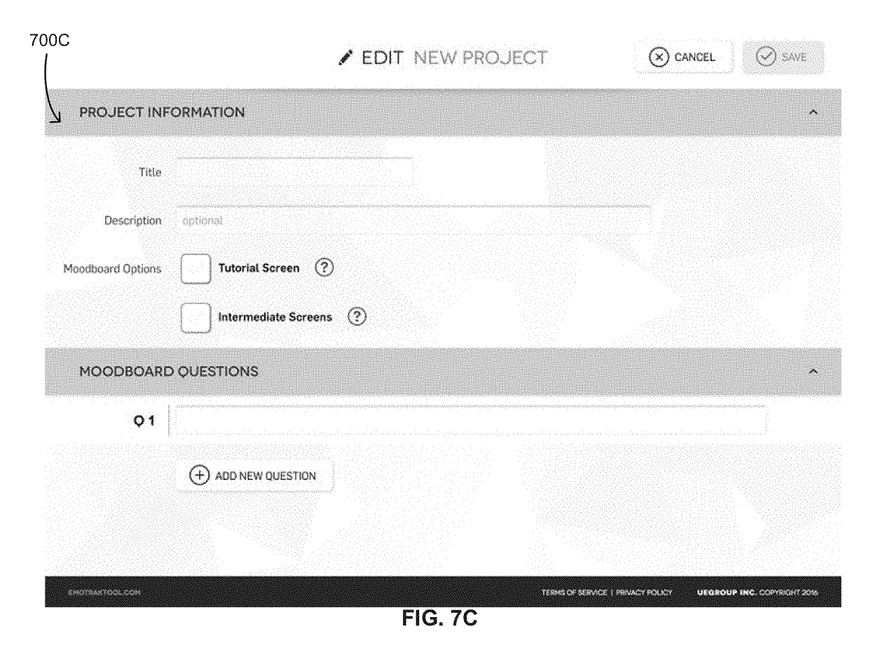

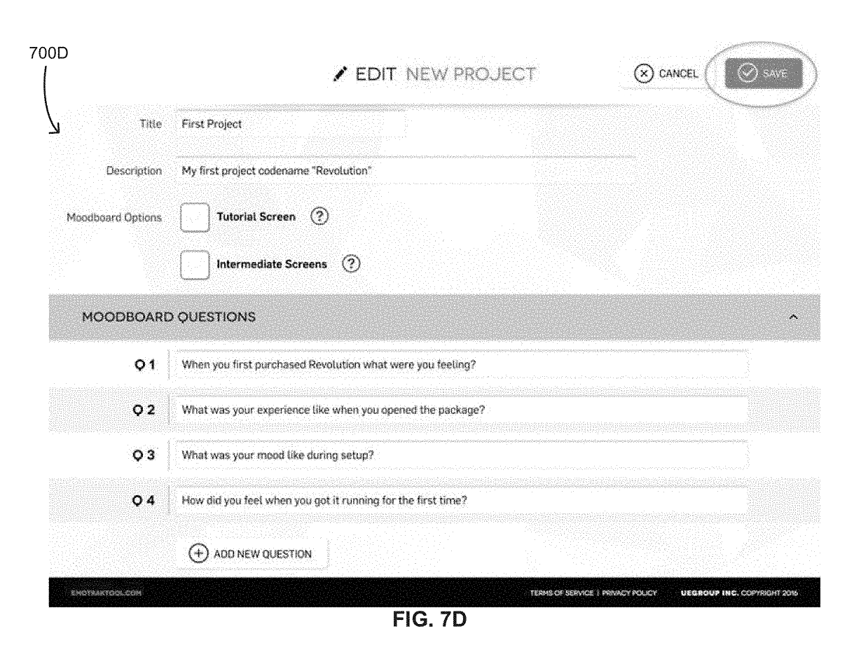

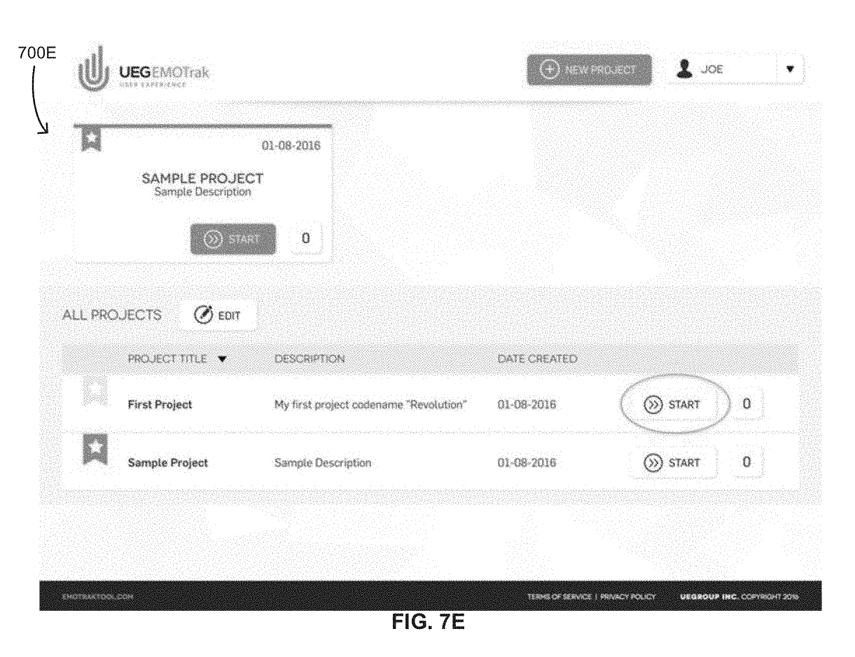

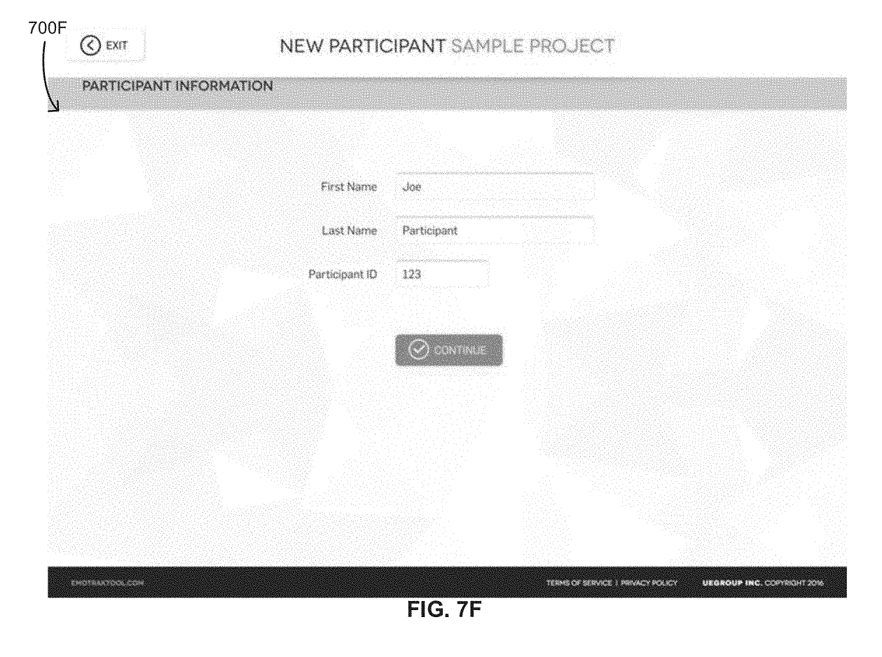

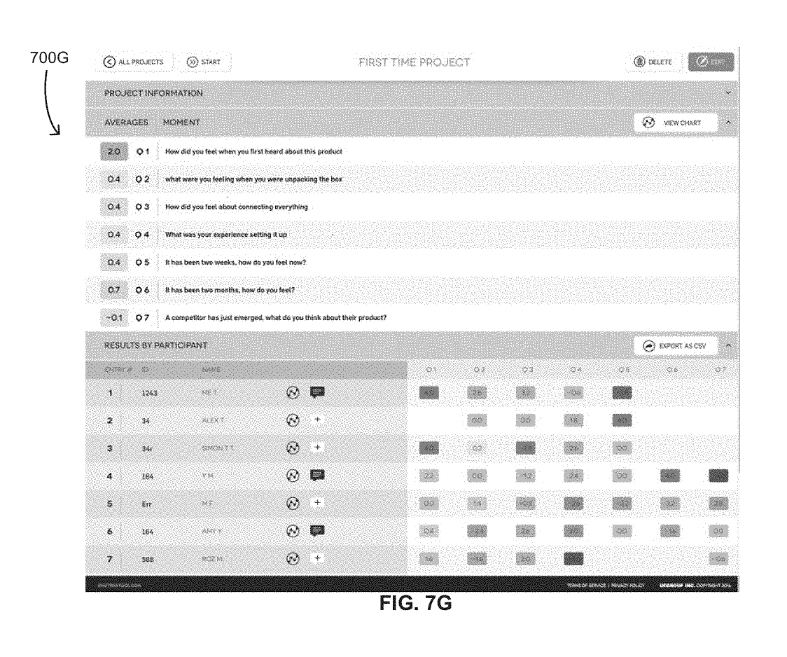

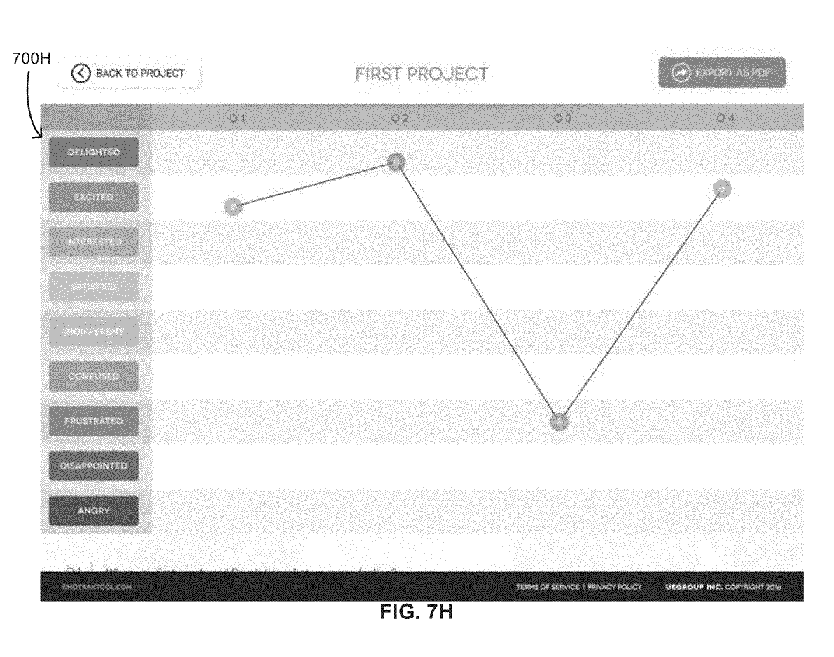

As shown in the general flow 200A of FIG. 2A, a researcher can start a new project in the perception and feeling reporting tool (see FIG. 7B) and configure a digitized chart or diagram to capture a participant's emotion, which digitized chart can be referred to as a “Moodboard” herein. The perception and feeling reporting tool can be configured to prompt the researcher to enter the new project's information as shown in FIG. 7C and FIG. 7D. The perception and feeling reporting tool can be configured to prompt for each participant's information (e.g., first name, last name, participant ID) as shown in interface 700F of FIG. 7F. The researcher can start a session with one or more participants. Each participant can self-report his or her mood with the digitized chart or diagram based on questions, videos, images, or other information conveyed to the participant. An example digitized emotional chart 300C is shown in FIG. 3C, which also shows an example of how self-reported emotion can be quantified by the perception and feeling reporting tool using an overlay of numerical values for emotional strength for coordinates of the digitized chart.

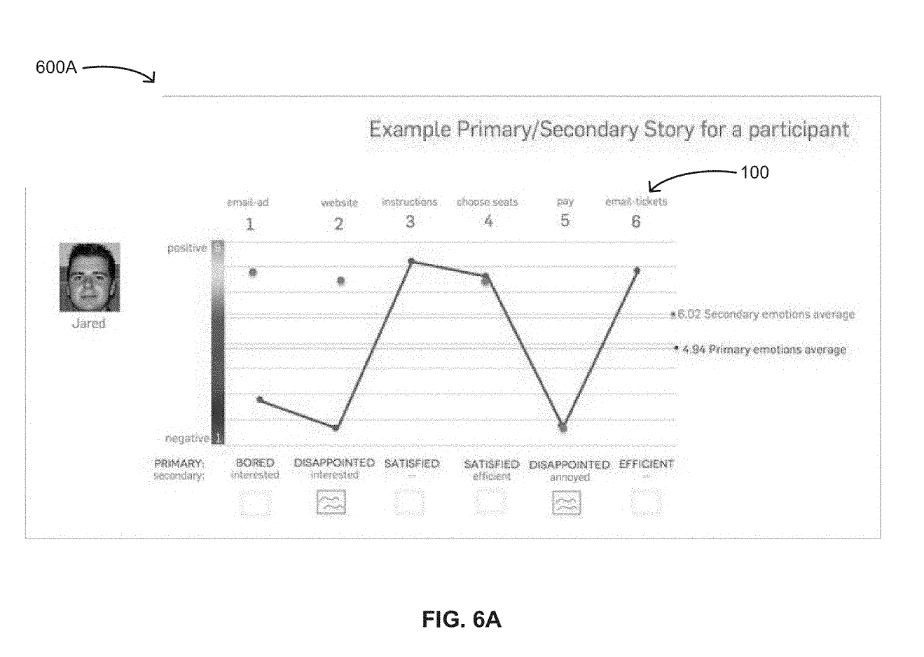

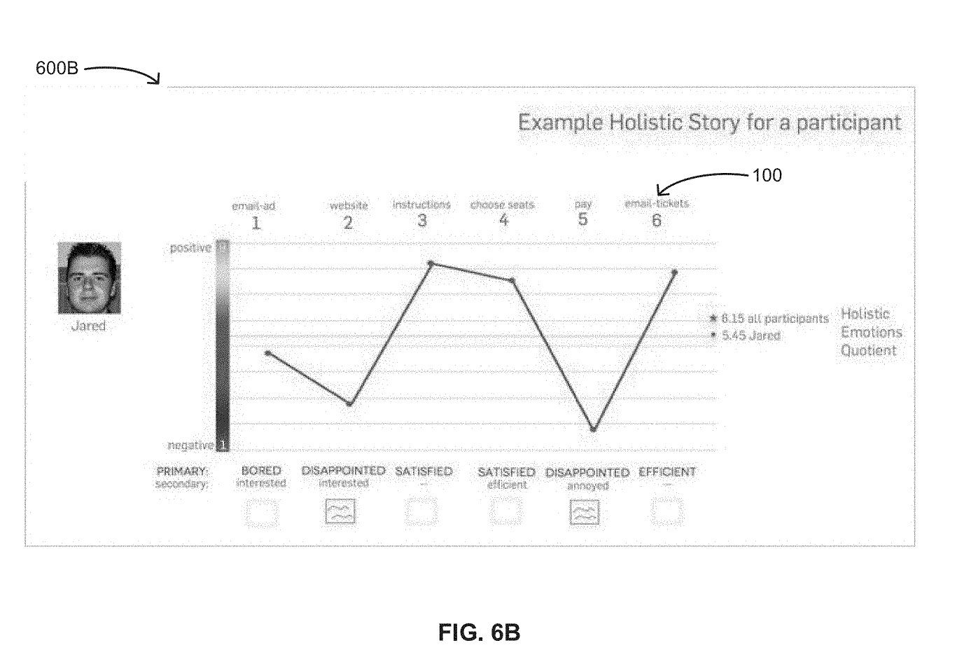

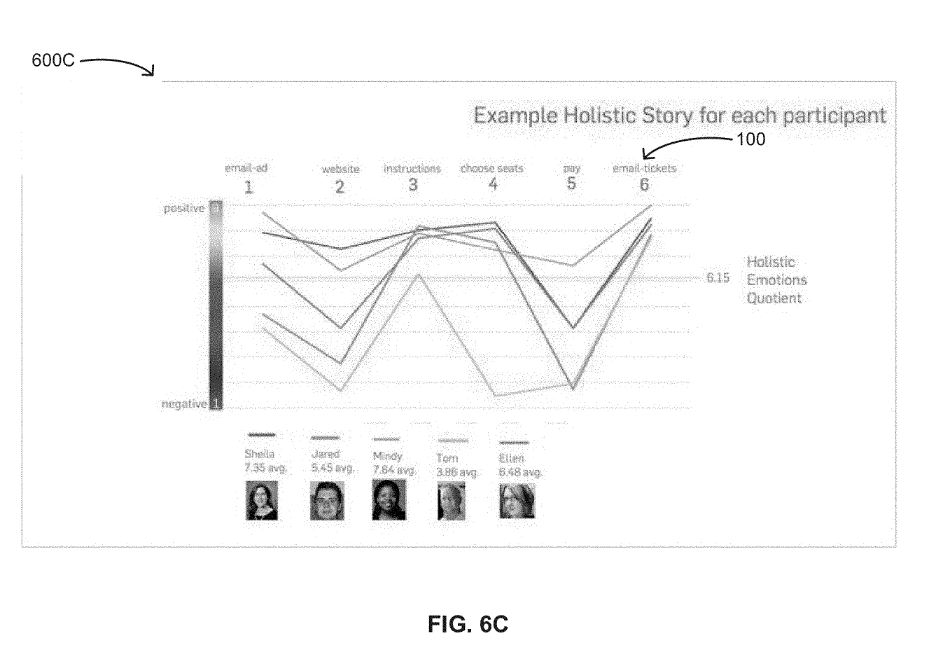

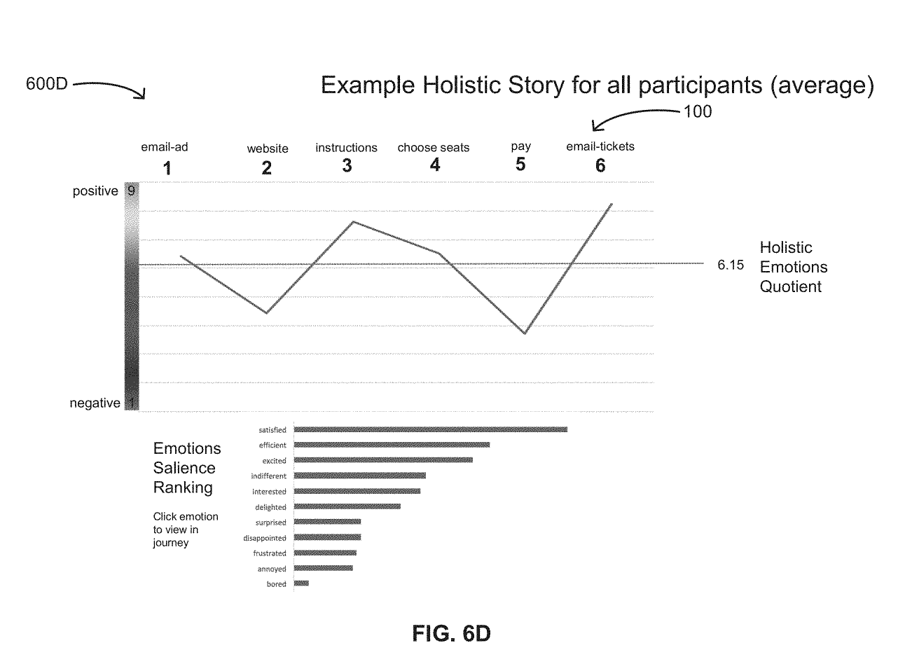

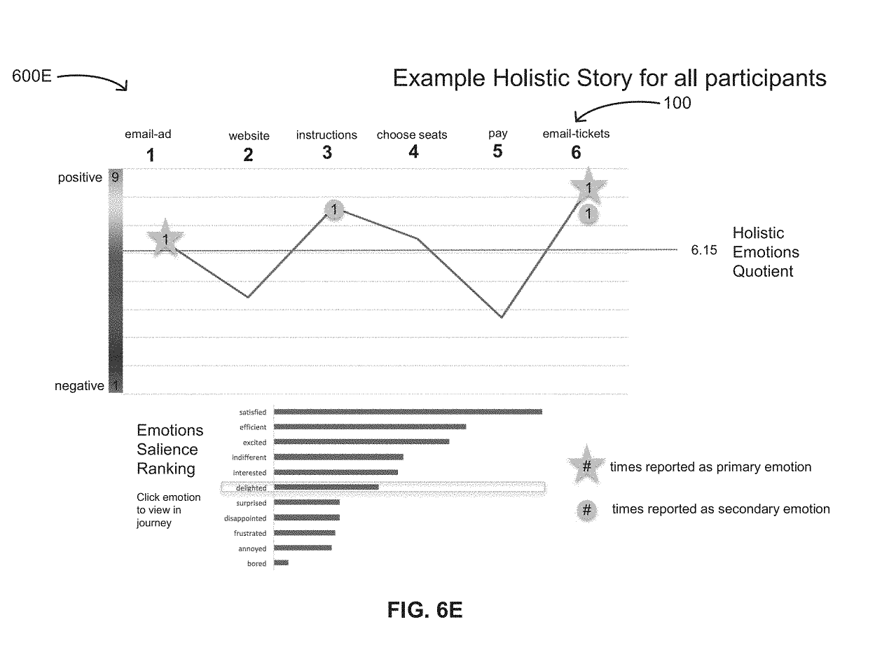

Participant can complete answering questions on the digitized emotional chart. The perception and feeling reporting tool can be configured to prompt to check if there are additional participants, for example, by asking for an affirmative “Yes” or “No.” The perception and feeling reporting tool can be configured to record the responses from the participants. The perception and feeling reporting tool can be configured to quantify emotions in the responses. The perception and feeling reporting tool can be configured to organize and display the quantified emotions, so that the researcher can review the results from participant(s) mood answers. (See FIG. 7G and FIG. 7H.) The perception and feeling reporting tool can be configured to store and format that data of the quantified emotions and results from participant(s) mood answers in an exportable format. The perception and feeling reporting tool can be configured to allow a user with the appropriate authorization, such as the researcher, to export the data. (See FIGS. 7G and 7H.) A module of the perception and feeling reporting tool can be configured to show the translated values and allow people to export them. The perception and feeling reporting tool can be configured to display results for an individual participant or aggregate of all the participants, wherein the emotions can be quantified and results from participant(s) mood answers can be presented in a digitized emotional chart. (See FIG. 6A, FIG. 6B, FIG. 6C, FIG. 6D, FIG. 6E, FIG. 7G, and interface 700H of FIG. 7H.) The researcher can visualize one or more emotional charts from participant data on the display screen of a computing device. The module can obtain the raw data that was produced from participants selecting a color and/or numeric value in a matrix. The selected color and/or numeric value in the matrix by the participant corresponds to a visual representation of the participant's emotions, and other visual representations can be used. Others users can obtain this same raw data and do their own analysis by averaging and doing other things with the data. Note, internally custom color mapping can be supported by the tool.

A possible flow 200B for the participant to self-report their mood based on questions in the perception and feeling reporting tool with the digitized chart or diagram to capture a participant's emotion during multiple times during the study can be as follows:

As shown in the flow 200B of FIG. 2B, the perception and feeling reporting tool can be configured to prompt for participant information (e.g., first, last name, participant ID) as shown in FIG. 7F. The perception and feeling reporting tool can be configured to display participant questions, videos, images, or other information conveyed to the participant and clear the digitized Moodboard about to be presented from any previous responses. The tool can be configured to present additional follow up questions, based on the participant's previous response, to gain greater detail and insight. The participant answers with an emotional state to the questions, videos, images, or other information conveyed to the participant by selecting the type and intensity of “emotion” on the digitized Moodboard as shown in FIG. 3A or FIG. 3B. The perception and feeling reporting tool can be configured to highlight the user's selection with check mark as shown in FIG. 3A or FIG. 3B. Alternatively, a confirmation pop up window to increase the integrity of the results to eliminate when participants would accidentally select the wrong emotion, which would result in incorrect data. Thus, the confirmation pop up window or highlighting the selection can be added to visually show a confirmation when a selection is made.

A digitized chart or Moodboard as shown in FIG. 3A or FIG. 3B can specify emotion-to-numerical-value mapping and associated colors as shown in FIG. 3C. The numeric value assigned in the chart can vary in scale and resolution. In other words, the chart can be much bigger and the number association much larger or smaller. A participant can answer a question by selecting on the grid to report a mood or emotion, wherein the grid reflects participant's tendency to consider the left side of the grid as the negative end of the rating scale. A numerical value can be assigned to that selection as shown in FIG. 3C with an overlay of numerical values for emotional strengths for coordinates of the digitized chart; however, the numerical values need not be presented to a participant. (See FIG. 3A or FIG. 3B.) The “Indifferent” column of FIG. 3C has a value of 0 (zero), though different versions of a Moodboard can quantify “Indifferent” differently or use a different emotion word for a numerical mapping of zero, as the perception and feeling tool is configured to give a researcher such control. A participant can answer questions or respond to other stimulus such as videos, images, moments in time, or other events and select on the grid to report their perceptions and feelings.

One can treat this table as a spreadsheet with table entries at specific coordinates. For example, the left, top entry of 3.2 is at row 0, column 0, with coordinates (0, 0). Entry 2.2 has coordinates (0, 1).

The following is some pseudocode to calculate the emotion results:
Pre-conditions:
   1. A data structure that defines the above grid (i.e. two dimensional array)
   2. A data structure that stores list of questions
   3. A data structure that stores participant emotion selections for each question
For each question in list of questions
   For each participant in list of participants
      Get numerical value for reported emotion for this question
      Add to accumulated numerical value for this question
      Calculate average numerical value for this question
      Save averaged numerical value for this question
Save results in database

The result can be a list of questions with corresponding average emotional values for each question with corresponding color coding, as shown in the following examples in Table 1:

TABLE 1
Example list of questions with corresponding
average emotional values for each question

| Averaged Emotional | |
|---|---|
| Values | Questions |
| 1.2 | Question 1 |
| −1.1 | Question 2 |

The analytics module can have a first algorithm that does simple linear averaging for matrix values and use an algorithm to map a participant's selection to the matrix value. In addition, a second algorithm can do a weighted averaging for the matrix value. The second algorithm can do weighting of what the participants said and then providing overall “mood.”

The tool can allow for multiple sessions with participants and aggregate or compare the multiple sessions. For example, a participant can answer a same set of questions during two different time periods. The answers from the two time periods can be visualized on the same chart. The same can be done for comparing responses from different participants.

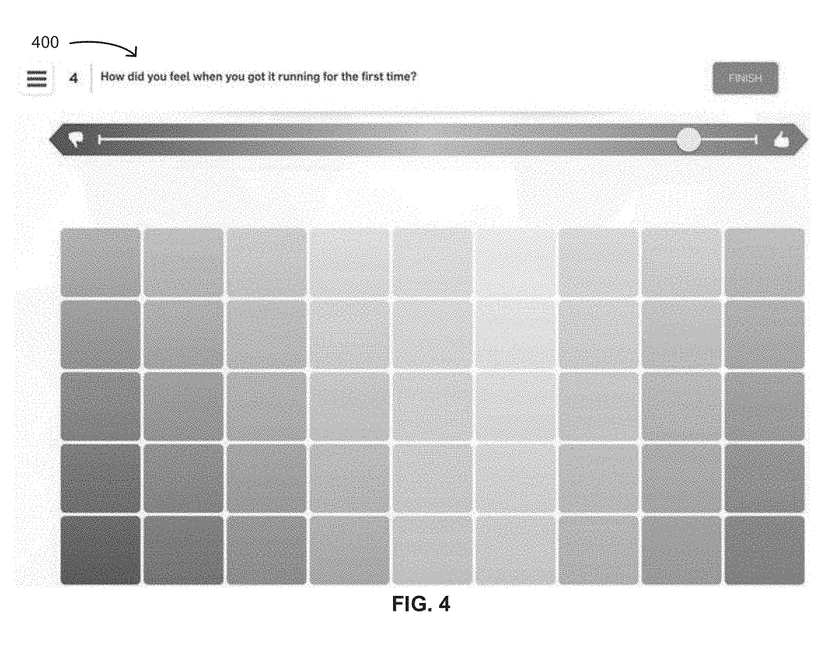

As shown in FIG. 3C, numeric values can be assigned to each emotion category in the presented digitized chart or similar diagram and intensity scale to improve the accuracy of the output, for the emotional journey chart; however the numeric values can be hidden from a participant's view per FIG. 3A and FIG. 3B. The tool associates values with the matrix positions, etc. The tool can be used in a couple of ways. The first can be participants pressing on a position in a matrix of described emotion that the tools associates with a value. In an alternate embodiment shown in interface 400 of FIG. 4, the participants can express their feelings in the perception and feeling reporting tool with a slider bar on the screen or other interactive expression, including hand gestures, that have been configured to map to a value and ultimately to a position on the matrix for reporting purposes. In alternate embodiments, the slider bar can be used when participants feel that a single emotion selection is not sufficient to reflect their mood. The horizontal slider allows for a more encompassing means to describe emotion, where the left can be increasingly negative and the right increasingly positive.

FIG. 5A and FIG. 5B provide alternative interfaces to the foregoing digitized charts or similar diagrams, wherein the alternative interfaces are also configured to enable a participant to self-report his or her perceptions or feelings from pre-selected emotion words for one or more moments of a study. As shown, the alternative interfaces of FIG. 5A and FIG. 5B can provide a selectable list of buttons corresponding to the emotion words as well as a slider for an associated intensity (e.g., “a little,” “somewhat,” “very much”) for a selected emotion word. The selectable list of buttons corresponding to the emotion words in the alternative interfaces of FIG. 5A and FIG. 5B are merely examples as selection of the emotion words can be implemented in any style of input control. For example, the buttons can instead be checkboxes, radio buttons, or toggles for the list of emotion words; the list of emotion words can be included in dropdown lists, list boxes, or dropdown buttons; or selectable icons, emojis, or images in an image carousel can be used for the list of emotion words. Indeed, any type of stimulus including one or more pictures, photos, videos, sounds, music, etc. can be used to enable a participant to self-report his or her perceptions or feelings. Likewise, any style of input control can be used for the associated intensity of a selected emotion word. Any combination that minimizes instructions on participants' selection of the emotion words, as well as the intensity of the selected emotion words, while achieving a balance between a desired granularity of the emotional responses is desired and can be effected using the various interfaces provided herein.

Not only do FIG. 5A and FIG. 5B provide alternative interfaces to the foregoing digitized charts or similar diagrams, but the interfaces of FIG. 5A and FIG. 5B, together, can provide collection-module collectable raw data for primary and second emotions for one or more moments during a study. As shown in FIG. 5A, the button corresponding to “Interested” in the list of emotion words is selected with an intensity on the associated slider between “somewhat” (interested) and “very much” (interested) for a primary emotion (e.g., “I feel mostly . . . ”). As shown in FIG. 5A, the button corresponding to “Confused” in the list of emotion words is selected with an intensity on the associated slider between “a little” (confused) and “somewhat” (confused) for a secondary emotion (e.g., “I also feel . . . ”). For example, the foregoing primary and secondary emotions can correspond to the moment of the receipt of the e-mail with the advertisement for the particular event described in reference to FIG. 1.

To configure a study to utilize primary and secondary emotions, a researcher can select moments as described herein at which to obtain participants' reactions, for example, during use of a product or service. At each of these moments, a participant is prompted to provide—through interfaces such as those provided in FIGS. 5A and 5B or the like—his or her primary emotion, and, subsequently, his or her secondary emotion from a textual or graphical list of emotions. The secondary emotion is optional.

The list of emotions can include any of a number of possible emotion words. For example, the textual list of emotion words provided in FIG. 5A and FIG. 5B includes 14 possible emotions. Studies can expand the foregoing list or condense the foregoing list to just some of the emotion words, each of which list of emotion words can be tailored to the nature of the study such as the product or service being tested in a usability-testing study. Each of the emotion words can have defined valence metrics or a defined emotional valence in accordance with psychological theory or empirical refinements thereof. In addition, metrics based on dimensions of emotion other than emotional valence can be used.

The weight of primary and secondary emotions can be determined using one or more analytical modules having algorithms provided herein that include the intensity of the primary and secondary emotions such as that provided by participants using the emotional intensity slider of FIG. 5A and FIG. 5B. Using the emotional intensity slider, a participant in a study can choose, for example, an emotional intensity for the primary emotion at 75% (e.g., “Interested” between “somewhat” interested and “very much” interested per FIG. 5A) and an emotional intensity for the secondary emotion at 25% (e.g., “Confused” between “a little” confused and “somewhat” confused per FIG. 5B). In some embodiments, the emotional intensity of the primary emotion can range from 55% to 100% combined with the algorithms provided herein, which can be adjusted per empirical refinements. A participant can also provide an emotional intensity for a primary or secondary emotion on scale of 1 to 10 through an alternative input control mechanism.

The emotional data points that can be collected as raw data by the collection module for each participant for each moment in a study can include the following:
p=valence of primary emotion
q=intensity of primary emotion
s=valence of secondary emotion (if chosen)
t=intensity of secondary emotion (if chosen)

From the foregoing emotional raw data, the following outcomes can be derived by the one or more analytical modules: Primary Emotion Score (“PES”); Secondary Emotion Score (“SES”); and Holistic Emotions Quotient (“HEQ”). In addition, an Emotion Salience Ranking (“ESR”) can be derived in some embodiments.

In some embodiments, the algorithms for the PES can include the following:
If p 4.0 then PES=p−(q×0.1)
If 4.0<p<5.0 then PES=p
If p≧5.0 then PES=p+(q×0.1)

With respect to the foregoing embodiment of the PES, if a participant in a study picks a primary emotion from a textual or graphical list of emotions and the defined emotional valence p of the primary emotion is between 4.0 and 5.0 (not inclusive), then the PES of the participant for the corresponding moment in the study is the defined emotional valence p without any added or subtracted weight from the emotional intensity q (e.g., from the emotional intensity slider). If the participant in the study picks a primary emotion from the textual or graphical list of emotions and the defined emotional valence p of the primary emotion is less than or equal to 4.0, then the PES of the participant for the corresponding moment in the study is downwardly weighted by subtraction of the product of the emotional intensity q and a coefficient (i.e., the product of q×0.1) from the defined emotional valence p. If the participant in the study picks a primary emotion from the textual or graphical list of emotions and the defined emotional valence p of the primary emotion is greater than or equal to 5.0, then the PES of the participant for the corresponding moment in the study is upwardly weighted by addition of the product of the emotional intensity q and a coefficient (i.e., the product of q×0.1) to the defined emotional valence p. The foregoing algorithms for the PES spread out PES values to facilitate better visualization in a plot of the PES values.

In some embodiments, the algorithms for the SES can include the following:
If s≦4.0 then SES=s−(t×0.1)
If 4.0<s<5.0 then SES=s
If s≧5.0 then SES=s+(t×0.1)

With respect to the foregoing embodiment of the SES, if a participant in a study picks an optional secondary emotion from a textual or graphical list of emotions and the defined emotional valence s of the secondary emotion is between 4.0 and 5.0 (not inclusive), then the SES of the participant for the corresponding moment in the study is the defined emotional valence s without any added or subtracted weight from the emotional intensity t (e.g., from the emotional intensity slider). If the participant in the study picks a secondary emotion from the textual or graphical list of emotions and the defined emotional valence s of the secondary emotion is less than or equal to 4.0, then the SES of the participant for the corresponding moment in the study is downwardly weighted by subtraction of the product of the emotional intensity t and a coefficient (i.e., the product of t×0.1) from the defined emotional valence s. If the participant in the study picks a secondary emotion from the textual or graphical list of emotions and the defined emotional valence s of the secondary emotion is greater than or equal to 5.0, then the SES of the participant for the corresponding moment in the study is upwardly weighted by addition of the product of the emotional intensity t and a coefficient (i.e., the product of t×0.1) to the defined emotional valence s. The foregoing algorithms for the SES spread out SES values to facilitate better visualization in a plot of the SES values.

FIG. 6A provides an interface 600A configured to enable a researcher to review a participant's emotions during one or more moments by the participant's PESs and the SESs for the one or more moments in accordance with some embodiments. As shown in interface 600A using the same one or more moments 100 described in reference to FIG. 1, the participant expressed he was primarily bored and secondarily interested in a) receipt of the e-mail with the advertisement for the particular event; primarily disappointed and secondarily interested in b) the web-based visit to the on-line ticket vendor by clicking through the e-mail advertisement; primarily satisfied with no secondary emotion for c) receipt of the instructions for finding the seat for the particular event in the particular venue; primarily satisfied with no secondary emotion for d) the graphical means for choosing the one or more seats in the particular venue; primarily disappointed and secondarily annoyed in e) paying for the tickets for the one or more seats in the payment-processing user interface; and primarily efficient with no secondary emotion for f) receipt of the tickets for the particular event via e-mail. As shown, the PESs and the SESs can indicate degrees with which the participant perceived or felt the primary and secondary emotions during the one or more moments. In addition, averages for the PESs and SESs can be used in the interface 600A to express whether the participant's PESs and SESs were generally more positive or negative.

The interface 600A and the chart thereof (as well as other such charts provided herein) can display an “emotional journey” of one or more participants using an aggregate of the emotion selections for each question. As shown in FIG. 7H, for example, the chart or emotional journey can be exported to another file such as pdf. The output can feed the input of other related or unrelated tools. A third party tool can take the assessment of emotions that results from this product and factor it in as part of their digital method. For example, a patient assessment package can use the output to assess whether the taker of a pharmaceutical is emotionally prepared to alter their medical regime.

In some embodiments, the algorithms for the Holistic Emotions Quotient (HEQ) can include the following:
If q>t then HEQ=PES(0.8)+SES(0.2)
If t=q then HEQ=PES (0.7)+SES (0.3)
If t>q then HEQ=PES(0.6)+SES (0.4)
If t=NA then HEQ=PES

With respect to the foregoing embodiment of the HEQ, if a participant in a study picks a primary emotion from a textual or graphical list of emotions without picking a secondary emotion, then the HEQ of the participant for the corresponding moment in the study is the PES. If the participant in the study picks a primary emotion and a secondary emotion from the textual or graphical list of emotions, and if the participant provides equal emotional intensities q and t for the primary emotion and the secondary emotion, respectively, then the HEQ is weighted more toward the PES (70%) than the SES (30%). This takes into account the fact that the participant identified the primary emotion first as the dominant emotion. If the participant in the study picks a primary emotion and a secondary emotion from the textual or graphical list of emotions, and if the participant provides a greater emotional intensity q for the primary emotion and a lesser emotional intensity t for the secondary emotion, then the HEQ is weighted more toward the PES (80%) than the SES (20%). The HEQ weighted in this way takes into account the fact that the strongly identified with the primary emotion for the corresponding moment in the study. If the participant in the study picks a primary emotion and a secondary emotion from the textual or graphical list of emotions, and if the participant provides a greater emotional intensity t for the secondary emotion and a lesser emotional intensity q for the primary emotion, then the HEQ is weighted more toward the SES (40%) than in other scenarios. The HEQ weighted in this way takes into account the fact that the strongly identified with the secondary emotion for the corresponding moment in the study.

FIG. 6B provides an interface 600B configured to enable a researcher to review a participant's emotions during one or more moments by the participant's HEQs for the one or more moments in accordance with some embodiments. The participant's emotions or HEQs during the one or more moments form a holistic story of the participant's experience. As shown in interface 600B using the same one or more moments 100 described in reference to FIG. 1, the participant expressed he was primarily bored and secondarily interested in a) receipt of the e-mail with the advertisement for the particular event; primarily disappointed and secondarily interested in b) the web-based visit to the on-line ticket vendor by clicking through the e-mail advertisement; primarily satisfied with no secondary emotion for c) receipt of the instructions for finding the seat for the particular event in the particular venue; primarily satisfied with no secondary emotion for d) the graphical means for choosing the one or more seats in the particular venue; primarily disappointed and secondarily annoyed in e) paying for the tickets for the one or more seats in the payment-processing user interface; and primarily efficient with no secondary emotion for f) receipt of the tickets for the particular event via e-mail. As shown, the HEQs can indicate degrees with which the participant perceived or felt both the primary and secondary emotions (in combination) during the one or more moments. In addition, an average for the HEQs can be used in the interface 600B to express whether the participant's HEQs were generally more positive or negative. The average HEQ for the participant can also be used to determine whether the participant was more positive or negative than a group of participants.

FIG. 6C provides an interface 600C configured to enable a researcher to review a group of participants and their emotions during one or more moments by the participants' HEQs for the one or more moments in accordance with some embodiments. The participants' emotions or HEQs during the one or more moments form holistic stories of the participants' experiences, which holistic stories—when viewed in aggregate in the interface 600C—can provide high-level insight into positive and negative experiences on behalf of the group of participants for the one or more moments. For example, as shown in interface 600C using the same one or more moments 100 described in reference to FIG. 1, the participants were generally positive about their experiences with a) receipt of the e-mail with the advertisement for the particular event; c) receipt of the instructions for finding the seat for the particular event in the particular venue; d) the graphical means for choosing the one or more seats in the particular venue; and f) receipt of the tickets for the particular event via e-mail; however, the participants had less positive experiences with b) the web-based visit to the on-line ticket vendor by clicking through the e-mail advertisement and e) paying for the tickets for the one or more seats in the payment-processing user interface. Furthermore, the average HEQ indicates the overall experience was generally positive.

In some embodiments, the algorithms for the ESR can include the following:
i) For each primary emotion: Multiply the frequency of the primary emotion by the mean emotional intensity for the primary emotion, then multiply the resulting product by 0.75 for x
ii) For each secondary emotion: Multiply the frequency of the secondary emotion by the mean emotional intensity for the secondary emotion, then multiply the resulting product by 0.25 for y
iii) For each emotion: Add x and y, then rank the emotions
   As such, the ESR algorithms consider each reported emotion's frequency, mean intensity, and rank with respect to being a primary or secondary emotion.

FIG. 6D provides an interface 600D configured to enable a researcher to review a group of participants and their perceptions or feelings by the participants' average HEQs during one or more moments in accordance with some embodiments. In addition, the interface 600D provides a related ESR for a number of emotions. Each of the emotions in the ESR is clickable in that a researcher is enabled to click any emotion word to see in which one or more moments the emotion word was reported in, as well as a frequency of the emotion word as a primary emotion or a secondary emotion.

FIG. 6E provides an interface 600E also configured to enable a researcher to review a group of participants and their perceptions or feelings by the participants' average HEQs during one or more moments in accordance with some embodiments. The interface 600E also provides the related ESR for the number of emotions shown in FIG. 6D for the interface 600D. Indeed, as shown between FIG. 6D and FIG. 6E, the researcher clicked the emotion word “delighted” in the interface 600D to provide the interface 600E in which “delighted” is highlighted. Concomitant with the foregoing, the participants' average HEQs were annotated by moment to reflect the number of times “delighted” was used as an emotion word for a primary emotion and the number of times “delighted” was used as an emotion word for a secondary emotion.

The analytics module can have a first algorithm that does simple averaging for the matrix value and uses an algorithm to map the slider to the matrix value. The perception and feeling reporting tool can be configured to quantify the emotion responses from the one or more participants. The perception and feeling reporting tool can be configured to save the results to a database. The perception and feeling reporting tool can be configured to convey questions, videos, images, or other information to the participant until all questions are answered. If additional questions remain, then the perception and feeling reporting tool can be configured to repeat the process again. The perception and feeling reporting tool can be configured to display to the participant the additional questions, videos, images, or other information the participant and clear the digitized interface about to be presented from any previous responses. When finished with all questions, the perception and feeling reporting tool can be configured to then display “Thank you for your participation.” The perception and feeling reporting tool can be configured to allow a plurality of participants in a study to utilize this tool to do self-reporting as a viable method for emotion capturing. Participants can conduct the study in a group or as individuals in separate locations.

An overall emotional ranking, or value, can be determined through an algorithm that analyzes i) a subset or ii) the entirety of the inputted values from the participants. The tool can display subsets of the data as well in the form of categories, for example, where several values are aggregated under one description and presented as a single value. Also, multiple languages can be supported for the same input. Users can express themselves using different languages but all the values will be associated with the same calculation. The tool can display its output on the device it is running on such as a tablet, desktop, smart phone as well as display its output on another one of these type of devices.

The module can be programmed to capture analytics such as the following: 1) How do these feelings change over the duration of the study? 2) What factors seem to statistically influence the group of participants? 3) How do demographic characteristics influence a particular moment or an emotional journey? The perception and feeling tool can be configured to collect demographic data in a demographics database to enable a researcher to determine such influencing factors. The module can also be configured to conform with different cultural interpretations and associations, optionally in accordance with the demographic data in the demographics database or from researcher-determined influencing factors. The perception and feeling reporting tool can also be programmed to give the ability to create and save multiple projects, label each question/step for perception and feeling reporting, define how many times each participant would be asked to chart, and stop participants from being able to see their previous answers. The emotion tool can also be programmed to progress through a study non-linearly and allows participants to be able to skip an entire step and/or skip individual questions in the process in a non-linear manner. If the study is running out of time to do a task or has to skip a task, the perception and feeling reporting tool allows participants to skip a step and/or questions. This prevents reporting a neutral emotion or non-emotion and the researcher manually removing that data during analysis.

### Example User Interfaces

FIGS. 7A-7J provide various interfaces for an example perception and feeling reporting tool including, but not limited to, interfaces for researcher sign-up, creating new projects or studies, entering Moodboard questions for the studies, and viewing results for the studies. The perception and feeling reporting can be configured to run on mobile devices including tablets in addition to desktops, laptops, and the like.

FIG. 7A provides an interface 700A configured to enable a researcher to sign up for an account on one or more servers or log in to an existing account on the one or more servers in accordance with some embodiments. The account enables the researcher to create, modify, conduct, and review various studies with the perception and feeling reporting tool.

FIG. 7B provides an interface 700B configured to enable a researcher to create a new study and modify any of a number of existing studies in accordance with some embodiments. The number of existing studies can be presented in an array of graphical elements (e.g., icons, tiles, cards, etc.) corresponding to the number of existing studies, in a list ordered by study name or study creation date, or in a combination as shown in FIG. 7B.

FIG. 7C provides an interface 700C configured to enable a researcher to edit a study in accordance with some embodiments. As shown, the interface 700C can enable a researcher to create or edit information for a study such as a title for the study, enter a description, and select one or more Moodboard options such as inclusion of a tutorial screen or intermediate screens. The tutorial screen can be configured to appear before the first moment or question. It allows participants to get a feel for how the perception and feeling reporting tool works. It also allows participants to practice how to enter their perceptions and feeling for each moment or question. The intermediate screens can be configured to allow users to pause between questions and/or wait for moderator instructions if such a moderator is present.

FIG. 7D provides an interface 700D further configured to enable a researcher to edit a study in accordance with some embodiments. As shown, the interface 700D follows on the interface 700C, wherein the interface 700D further includes researcher-created or edited study information and a number moments or questions for the study. The interface 700D can be configured to create a placeholder for each new moment or question subsequent to a researcher entering a moment or question via an “Enter” button or saving the moment or question by using the on-screen “Add new question” button. The interface can be further configured such that by using the on-screen “Save” button, the researcher can be returned to the interface 700B.

Moodboard questions need not be questions. For example, a researcher can query participants by entering “interaction moments” spanning an experience with a product, such as a video game. In such a case, the researcher can ask participants to select their mood during one or more of the following moments: 1) Looking at the game console package; 2) opening the package; 3) setting up the console; or 4) playing the first game.

FIG. 7E provides an interface 700E configured to enable a researcher to start a study in accordance with some embodiments. From such an interface, a researcher can initiate a session of the study by selecting the on-screen “Start” button adjacent the desired study. The interface 700E can be configured such that frequently used or preferred studies appear in the array of graphical elements (e.g., icons, tiles, cards, etc.) provided herein.

FIG. 7F provides an interface 700F configured to enable a researcher to add participants to a study in accordance with some embodiments. Participant information such as a participant's name and a unique identifier can be entered in the interface 700F and stored in a participant database. One or more additional interfaces can be configured to add demographic information for participants in a study. The perception and feeling tool can be configured to use the demographic information stored in the participant database or a separate demographics database to determine if there are, for example, divisions in results for one or more moments in a study by age, gender, educational attainment, etc.

Subsequent to a researcher configuring a study with moments and/or question and participants, the researcher can conduct the study on one or more of the participants. The researcher can be a moderator with a digitized chart such as that shown in FIG. 3A or FIG. 3B, the on-screen slider bar of FIG. 4, and/or the interfaces of FIG. 5A and FIG. 5B, any one or more of which can be presented to a participant at an appropriate time using a desktop computer, laptop computer, or a mobile device such as a smart phone or a tablet. Alternatively, the researcher can send (e.g., via web link) the study (e.g., on-line study) to one or more participants for completion at time of choosing for the one or more participants. Alternatively, the study can be built into a web site, and, at various moments provided through the web site, a javascript pop-up on the web site can gather participants' perceptions and feelings. For any one or more of the foregoing, biometrics, application programming interfaces (“APIs”), or a combination thereof (e.g., APIs for the biometrics) can be also used to gather perceptions and feelings, or, at least, validate the perceptions and feelings provided by participants. Regardless, once the one or more participants report their perceptions and feelings to the one or more questions and/or moments of the study (e.g., by selecting an appropriate Moodboard box or an emotion word and its emotional intensity), the results can be provided to the researcher.

The perception and feeling reporting tool can be implemented on a tablet, smart phone, or other mobile device with a mobile version of the emotional chart. The perception and feeling reporting tool has features included the ability to create and save multiple projects, label each question/step for perception and feeling reporting, define how many times each participant would be asked to chart, and stop participants from being able to see their previous answers. The perception and feeling reporting tool has been configured to capture participant ratings and feedback at multiple times during the study to capture nuances that occurred during the study, such as the emotion data shows which steps of the study process or parts of the product elicited frustration or delight.

The perception and feeling reporting tool can be a SaaS tool that allows researchers to track the self-reported emotional states of a person through an experience. The perception and feeling reporting tool gathers data about the emotional journey of a user experience and customer experience to product, service or other thing. The perception and feeling reporting tool captures the emotional experience of a product or other focus of the study, with an emphasis on an agile self-reporting method. The perception and feeling reporting tool can be programmed for product and market research, but it could also be applied to many other situations such as pharmaceuticals, where a patient is considering taking a new drug as part of a clinical study, etc. The labels on the digitized matrix would be tailored to that other situation such as an amount of comfort/discomfort or pleasure/pain felt verses level of emotions as currently indicated in an embodiment of the digitized matrix. The labels used in the illustration, such as angry, frustrated, etc. can be substituted with either alternative terms or graphical presentations of ideas. The tool can incorporate or combine with biometric methods, such as facial recognition, to provide greater resolution or greater accuracy for those tools. The digitized chart or diagram acts as a digital input device to capture the perception and feelings of the participant. However, other forms of the digital input device are possible.

The perception and feeling reporting tool can have other documents, or media, attached or associated with the input. For example, a video could be automatically or manually attached to the self-reporting of an emotion. The input can have a temporal component. The input can be assigned a time stamp and the algorithm make take into account the time the input was made in its calculation. The time can also be factored into the reporting including the possibility of creating animated presentations based on the input and associated media.

In view of the foregoing, provided herein in some embodiments are methods that include providing a perception and feeling tool having multiple modules configured to present a series of user interfaces. The series of user interfaces can be configured for allowing participants to express perceptions and feelings at multiple discreet points during a study in order to track the perceptions and feelings of each participant throughout the study. The series of user interfaces can be configured for recording the participants' perceptions and feelings at the multiple discreet points during the study as collected data. The series of user interfaces can be configured for displaying results for i) any one or more of the participants as well as ii) an aggregate of all the participants for the perceptions and the feelings at the multiple discreet points during the study to visually see the participants' perceptions and feelings at the multiple discreet points during the study. The methods can further include collecting raw data including the participants' perceptions and feelings from the user interfaces with a collection module configured for the collecting. In addition, the methods can further include applying analytics by one or more analytical modules to the raw data collected by the collection module in order to apply any of a linear algorithm, a weighted algorithm, or a combination of the linear algorithm and the weighted algorithm. Applying the analytics can be for determining any of 1) how the participants were feeling at the multiple discreet points during the study; 2) what the participants were perceiving at the multiple discreet points during the study; or 3) any combination thereof. Further in addition, the methods can include soliciting each participant of the study using a solicitation module configured for the soliciting, presenting the series of the user interfaces to the participants in the study, and allowing the participants to express the perceptions and feelings at the multiple discreet points during the study. One or more modules of the perception and feeling tool can be configured to cooperate with one or more processors on a computing device to execute instructions for any software portions of the one or more modules.

In such embodiments, the methods can further comprise displaying the results in a digitized chart or a similar diagram and reporting the results for i) the any one or more of the participants or ii) the aggregate of all the participants. The perception and feeling tool can be further configured as a reporting tool configured for the displaying and reporting.

In such embodiments, the methods can further comprise presenting with the solicitation module a first user interface including a digitized chart that has a set of at least 5 words conveying the perceptions and feelings along with any of a numeric indicator, a sliding scale, or a color to indicate an intensity for a selectable perception or feeling that a first participant is experiencing at a first discrete point during the study.

In such embodiments, the methods can further comprise receiving by the solicitation module one or more of the user interfaces of the series of user interfaces. The solicitation module can be resident in a client device and can be configured to cooperate with one or more servers or other computing devices for the receiving.

In such embodiments, the methods can further comprise aggregating participants' perceptions and feelings for all of the participants in the study, wherein the collection module is configured for the aggregating.

In such embodiments, the methods can further comprise presenting the user interfaces and collecting the raw data with the collection module. The perception and feeling tool can include the collection module configured for the collecting, and the raw data can be from participants selecting colors in matrices presented in the user interfaces, numeric values in the matrices, on-screen buttons corresponding to certain perceptions and feeling in the series of user interfaces, intensities for the certain perceptions and feelings, pictures, photos, videos, sounds, music, or a combination thereof. In such embodiments, the colors and the numeric values correspond to a visual representation, a quantifiable representation, or a visual and quantifiable representation of the participants' perceptions and feelings.

In such embodiments, the methods can further comprise formatting and storing 1) the raw data and 2) results from application of the one or more algorithms to quantify the perceptions and feelings from the participants in an exportable format, wherein the collection module is configured for the formatting and storing.

In such embodiments, the methods can further comprise allowing participants through the perception and feeling tool to express at least two perceptions and feelings at each of the multiple discreet points during the study in order to track primary and secondary perceptions and feelings of each participant throughout the study. In addition, the methods can further comprise allowing participants through the perception and feeling tool to express emotional intensities for the at least two perceptions and feelings at each of the multiple discreet points during the study.

In such embodiments, the methods can further comprise determining with the one or more analytical modules a primary emotion score (“PES”) for each primary perception and feeling and its emotional intensity, a secondary emotion score (“SES”) for each secondary perception and feeling and its emotional intensity, and a holistic emotions quotient for the PES and SES weighted in accordance with the emotional intensity of the PES and the emotional intensity of the SES.

### Computing System

FIG. 8 illustrates a block diagram of an example computing system that can be used in an embodiment of one or more of the servers and client devices discussed herein. The computing system environment 800 is only one example of a suitable computing environment, such as a client device, server, perception and feeling reporting tool electronic module, etc., and is not intended to suggest any limitation as to the scope of use or functionality of the design of the computing system 810. Neither should the computing environment 800 be interpreted as having any dependency or requirement relating to any one or combination of components illustrated in the exemplary operating environment 800.

With reference to FIG. 8, components of the computing system 810 can include, but are not limited to, a processing unit 820 having one or more processing cores, a system memory 830, and a system bus 821 that couples various system components including the system memory to the processing unit 820. The system bus 821 can be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) locale bus, and Peripheral Component Interconnect (PCI) bus.

Computing system 810 typically includes a variety of computing machine-readable media. Computing machine-readable media can be any available media that can be accessed by computing system 810 and includes both volatile and nonvolatile media, removable and non-removable media. By way of example, and not limitation, computing machine-readable mediums uses include storage of information, such as computer readable instructions, data structures, program modules or other data. Computer storage mediums include, but are not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other tangible medium which can be used to store the desired information and which can be accessed by computing device 800. However, carrier waves would not fall into a computer readable medium. Communication media typically embodies computer readable instructions, data structures, program modules, or other transport mechanism and includes any information delivery media.

The system memory 830 includes computer storage media in the form of volatile and/or nonvolatile memory such as read only memory (ROM) 831 and random access memory (RAM) 832. A basic input/output system 833 (BIOS), containing the basic routines that help to transfer information between elements within computing system 810, such as during start-up, can typically be stored in ROM 831. RAM 832 typically contains data and/or program modules that can be immediately accessible to and/or presently being operated on by processing unit 820. By way of example, and not limitation, FIG. 8 illustrates operating system 834, program modules 836, and program data 837.

The computing system 810 can also include other removable/non-removable volatile/nonvolatile computer storage media. By way of example only, FIG. 8 illustrates a hard disk drive 841 that reads from or writes to non-removable, nonvolatile magnetic media nonvolatile optical disk 856 such as a CD ROM or other optical media. Other removable/non-removable, volatile/nonvolatile computer storage media that can be used in the exemplary operating environment include, but are not limited to, USB drives and devices, magnetic tape cassettes, flash memory cards, digital versatile disks, digital video tape, solid state RAM, solid state ROM, and the like. The hard disk drive 841 can typically be connected to the system bus 821 through a non-removable memory interface such as interface 840, and magnetic disk drive 851 and optical disk drive 855 can typically be connected to the system bus 821 by a removable memory interface, such as interface 850.

The drives and their associated computer storage media discussed above and illustrated in FIG. 8, provide storage of computer readable instructions, data structures, program modules and other data for the computing system 810. In FIG. 8, for example, hard disk drive 841 is illustrated as storing operating system 844, program modules 846, and program data 847. Note that these components can either be the same as or different from operating system 834, program modules 836, and program data 837. Operating system 844, program modules 846, and program data 847 can be given different numbers here to illustrate that, at a minimum, they can be different copies.

A user can enter commands and information into the computing system 810 through input devices such as a keyboard 862, a microphone 863, a pointing device 861, such as a mouse, trackball or touch pad. The microphone 863 can cooperate with speech recognition software. These and other input devices can often be connected to the processing unit 820 through a user input interface 860 that is coupled to the system bus, but can be connected by other interface and bus structures, such as a parallel port, game port or a universal serial bus (USB). A display monitor 891 or other type of display screen device can also be connected to the system bus 821 via an interface, such as a video interface 890. In addition to the monitor, computing devices can also include other peripheral output devices such as speakers 897 and other output device 896, which can be connected through an output peripheral interface 890.

The computing system 810 can operate in a networked environment using logical connections to one or more remote computers/client devices, such as a remote computing device 880. The remote computing device 880 can be a personal computer, a hand-held device, a server, a router, a network PC, a peer device or other common network node, and typically includes many or all of the elements described above relative to the computing system 810. The logical connections depicted in FIG. 8 include a local area network (LAN) 871 and a wide area network (WAN) 873, but can also include other networks. Such networking environments are commonplace in offices, enterprise-wide computer networks, intranets and the Internet. A browser application can be resident on the computing device and stored in the memory.

When used in a LAN networking environment, the computing system 810 can be connected to the LAN 871 through a network interface or adapter 870. When used in a WAN networking environment, the computing system 810 typically includes a modem 872 or other means for establishing communications over the WAN 873, such as the Internet. The modem 872, which can be internal or external, can be connected to the system bus 821 via the user-input interface 860, or other appropriate mechanism. In a networked environment, program modules depicted relative to the computing system 810, or portions thereof, can be stored in the remote memory storage device. By way of example, and not limitation, FIG. 8 illustrates remote application programs 885 as residing on remote computing device 880. It will be appreciated that the network connections shown are exemplary and other means of establishing a communications link between the computing devices can be used.

As discussed, the computing system can include a processor, a memory, a built in battery to power the computing device, an AC power input, potentially a built-in video camera, a display screen, a built-in Wi-Fi circuitry to wirelessly communicate with a remote computing device connected to network.

It should be noted that the present design can be carried out on a computing system such as that described with respect to FIG. 8. However, the present design can be carried out on a server, a computing device devoted to message handling, or on a distributed system in which different portions of the present design can be carried out on different parts of the distributed computing system.

Another device that can be coupled to bus 811 is a power supply such as a battery and Alternating Current adapter circuit. As discussed above, the DC power supply can be a battery, a fuel cell, or similar DC power source that needs to be recharged on a periodic basis. The wireless communication module 872 can employ a Wireless Application Protocol to establish a wireless communication channel. The wireless communication module 872 can implement a wireless networking standard such as Institute of Electrical and Electronics Engineers (IEEE) 802.11 standard, IEEE std. 802.11-1999, published by IEEE in 1999.

Examples of mobile computing devices can be a laptop computer, a cell phone, a personal digital assistant, or other similar device with on-board processing power and wireless communications ability powered by a Direct Current (DC) power source that supplies DC voltage to the mobile device and that is solely within the mobile computing device and needs to be recharged on a periodic basis, such as a fuel cell or a battery.

### Network Environment

As discussed, FIG. 9 illustrates a block diagram of an embodiment of the network environment in which the techniques described can be applied. The network environment 200 has a communications network 220 that connects server computing systems 204A through 204F, and at least one or more client computing systems 202A, 202B. As shown, there can be many server computing systems 204A through 204F and many client computing systems 202A through 202B connected to each other via the network 220, which can be, for example, the Internet. Note, that alternatively the network 220 might be or include one or more of: an optical network, the Internet, a Local Area Network (LAN), Wide Area Network (WAN), satellite link, fiber network, cable network, or a combination of these and/or others. It is to be further appreciated that the use of the terms client computing system and server computing system is for clarity in specifying who generally initiates a communication (the client computing system) and who responds (the server computing system). No hierarchy is implied unless explicitly stated. Both functions can be in a single communicating device, in which case the client-server and server-client relationship can be viewed as peer-to-peer. Thus, if two systems such as the client computing system 202A and the server computing system 204A can both initiate and respond to communications, their communication can be viewed as peer-to-peer. Likewise, communications between the client computing systems 204A and 204-2, and the server computing systems 202A and 202B can be viewed as peer-to-peer if each such communicating devices are capable of initiation and response to communication. Additionally, server computing systems 204A-204F also have circuitry and software to communication with each other across the network 220. One or more of the server computing systems 204A to 204F can be associated with a database such as, for example, the databases 206A to 206F. Each server can have one or more instances of a virtual server running on that physical server and multiple virtual instances can be implemented by the design. A firewall can be established between a client computing system 202A and the network 220 to protect data integrity on the client computing system 202A. Each server computing system 204A-204F can have one or more firewalls.

In an embodiment, the perception and feeling reporting tool can be hosted on a cloud-based provider site that contains one or more servers 204A and one or more databases 206A.

A cloud provider service can install and operate application software in the cloud and users can access the software service from the client devices. Cloud users who have a site in the cloud cannot solely manage the cloud infrastructure and platform where the application runs. Thus, the servers and databases can be shared hardware where the user can be given a certain amount of dedicate use of these resources. The user can be given a virtual amount of dedicated space and bandwidth in a so-called cloud. Cloud applications can be different from other applications in their scalability—which can be achieved by cloning tasks onto multiple virtual machines at run-time to meet changing work demand. Load balancers distribute the work over the set of virtual machines. This process can be transparent to the cloud user, who sees only a single access point.

The cloud-based perception and feeling reporting tool can be coded to utilize a protocol, such as Hypertext Transfer Protocol (HTTP), to engage in a request and response cycle with both a mobile device application resident on a client device as well as a web-browser application resident on the client device. The cloud-based perception and feeling reporting tool can be accessed by a mobile device, a desktop, a tablet device, and other similar devices, anytime, anywhere. Thus, the cloud-based perception and feeling reporting tool hosted on a cloud-based provider site can be coded to engage in 1) the request and response cycle from all web browser based applications, 2) SMS/twitter based request and response message exchanges, 3) the request and response cycle from a dedicated on-line server, 4) the request and response cycle directly between a native mobile application resident on a client device and the cloud-based perception and feeling reporting tool, and 5) combinations of these.

The cloud-based perception and feeling reporting tool has one or more application programming interfaces (APIs) with two or more of the customer sites as well as application programming interfaces with search engines and social on-line sites, etc. The APIs can be a published standard for the connection to each site for access/connectivity′ system. The APIs can also be an open source API. One or more of the API's can be customized to closed/non-published APIs of a remote access/connectivity′ site. The cloud-based perception and feeling reporting tool can be coded to establish a secure communication link between each customer entity site and the cloud provider site. The software service can be coded to establish the secure communication link by creating a tunnel at the socket layer and encrypting any data while in transit between each customer entity sites and the provider site as well as to satisfy any additional authentication mechanisms required by that site, including but not limited to IP address white listing and token based authentication.

In an embodiment, the server computing system 204 can include a server engine, a web page management component, a content management component and a database management component. The server engine performs basic processing and operating system level tasks. The web page management component handles creation and display or routing of web pages or screens associated with receiving and providing digital content and digital advertisements. Users can access the server-computing device by means of a URL associated therewith. The content management component handles most of the functions in the embodiments described herein. The database management component includes storage and retrieval tasks with respect to the database, queries to the database, and storage of data.

An embodiment of a server computing system to display information, such as a web page, etc. An application including any program modules, when executed on the server computing system 204A, causes the server computing system 204A to display windows and user interface screens on a portion of a media space, such as a web page. A user via a browser from the client computing system 202A can interact with the web page, and then supply input to the query/fields and/or service presented by a user interface of the application. The web page can be served by a web server computing system 204A on any Hypertext Markup Language (HTML) or Wireless Access Protocol (WAP) enabled client computing system 202A or any equivalent thereof. For example, the client mobile computing system 202A can be a smart phone, a touch pad, a laptop, a netbook, etc. The client computing system 202A can host a browser to interact with the server computing system 204A. Each application has a code scripted to perform the functions that the software component can be coded to carry out such as presenting fields and icons to take details of desired information. Algorithms, routines, and engines within the server computing system 204A take the information from the presenting fields and icons and put that information into an appropriate storage medium such as a database. A comparison wizard can be scripted to refer to a database and make use of such data. The applications can be hosted on the server computing system 204A and served to the browser of the client computing system 202A. The applications then serve pages that allow entry of details and further pages that allow entry of more details.

### Scripted Code

In regards of viewing ability of an on-line site: the scripted code for the on-line site, such as a website, social media site, etc., can be configured or otherwise adapted to be i) viewed on tablets and mobile phones, such as individual downloadable applications in data stores designed to interface with the on-line site, ii) viewable on a screen in a vehicle or other mobile device, as well as iii) viewable on a screen of a desktop computer via a browser. Those skilled in the relevant art will appreciate that the invention can be practiced with other computer system configurations, including Internet appliances, hand-held devices, wearable computers, cellular or mobile phones, multi-processor systems, microprocessor-based or programmable consumer electronics, set-top boxes, network PCs, mini-computers, mainframe computers and the like.

Mobile web applications and native applications can be downloaded from a cloud-based site. The mobile web applications and native applications have direct access to the hardware of mobile devices (including accelerometers and GPS chips), and the speed and abilities of browser-based applications. Information about the mobile phone and the vehicle's location can be gathered by software housed on the phone.

One or more scripted routines for the cloud-based perception and feeling reporting tool can be configured to collect and provide features such as those described herein.

Any application and other scripted code components can be stored on a non-transitory computing machine-readable medium which, when executed on the server causes the server to perform those functions. The applications including program modules can be implemented as logical sequences of software code, hardware logic circuits, and any combination of the two, and portions of the application scripted in software code can be stored in a non-transitory computing device readable medium in an executable format. In an embodiment, the hardware logic consists of electronic circuits that follow the rules of Boolean Logic, software that contain patterns of instructions, or any combination of both.

The design can also be described in the general context of computing device executable instructions, such as program modules etc. being executed by a computing device. Generally, program modules include routines, programs, objects, applications, widget, plug-ins, and other similar structures that perform particular tasks or implement particular abstract data types. Those skilled in the art can implement the description and/or figures herein as computer-executable instructions, which can be embodied on any form of computing machine-readable media discussed herein.

Some portions of the detailed descriptions herein are presented in terms of algorithms/routines and symbolic representations of operations on data bits within a computer memory. These algorithmic descriptions and representations are the means used by those skilled in the data processing arts to most effectively convey the substance of their work to others skilled in the art. An algorithm/routine is here, and generally, conceived to be a self-consistent sequence of steps leading to a desired result. The steps can be those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like. These algorithms/routine of the application including the program modules can be written in a number of different software programming languages such as C, C++, Java, XML, HTML, or other similar languages.

Many online pages on a server, such as web pages, can be written using the same language, Hypertext Markup Language (HTML), which can be passed around using a common protocol—HTTP. HTTP is the common Internet language (dialect, or specification). Through the use of a web browser, a special piece of software that interprets HTTP and renders HTML into a human-readable form, web pages authored in HTML on any type of computer can be read anywhere, including telephones, PDAs and even popular games consoles. Because of HTTP, a client machine (like your computer) knows that it has to be the one to initiate a request for a web page; it sends this request to a server. A server can be a computing device where web sites reside—when you type a web address into your browser, a server receives your request, finds the web page you want, and sends it back to your desktop or mobile computing device to be displayed in your web browser. The client device and server can bilaterally communicate via a HTTP request & response cycle between the two.

It should be borne in mind, however, that all of these and similar terms are to be associated with the appropriate physical quantities and are merely convenient labels applied to these quantities. Unless specifically stated otherwise as apparent from the above discussions, it is appreciated that throughout the description, discussions utilizing terms such as “processing” or “computing” or “calculating” or “determining” or “displaying” or the like, refer to the action and processes of a computing system, or similar electronic computing device, that manipulates and transforms data represented as physical (electronic) quantities within the computing system's registers and memories into other data similarly represented as physical quantities within the computing system memories or registers, or other such information storage, transmission or display devices.

Although embodiments of this design have been fully described with reference to the accompanying drawings, it is to be noted that various changes and modifications will become apparent to those skilled in the art. Such changes and modifications are to be understood as being included within the scope of embodiments of this design as defined by the appended claims. The invention is to be understood as not limited by the specific embodiments described herein, but only by scope of the appended claims.

What is claimed is:

1. An apparatus, comprising:
a perception and feeling tool having multiple modules and configured to present a series of user interfaces to
allow participants to express perceptions and feelings at multiple discreet points during a study in order to track the perceptions and feelings of each participant throughout the study,
record the participants' perceptions and feelings at the multiple discreet points during the study as collected data, and
display results for
i) any one or more of the participants as well as
ii) an aggregate of all the participants for the perceptions and the feelings at the multiple discreet points during the study to visually see the participants' perceptions and feelings at the multiple discreet points during the study;
a collection module configured to collect raw data including the participants' perceptions and feelings from the user interfaces;
one or more analytical modules configured to apply analytics to the raw data collected by the collection module in order to apply any of a linear algorithm, a weighted algorithm, or a combination of the linear algorithm and the weighted algorithm to determine any of
1) how the participants were feeling at the multiple discreet points during the study,
2) what the participants were perceiving at the multiple discreet points during the study, or
3) any combination of 1) and 2); and
a solicitation module configured to solicit each participant of the study by presenting the series of the user interfaces to the participants in the study and allowing the participants to express the perceptions and feelings at the multiple discreet points during the study,
wherein one or more modules of the perception and feeling tool are configured to cooperate with one or more processors on a computing device to execute instructions for any software portions of the one or more modules.

2. The apparatus of claim 1,
wherein the perception and feeling tool is further configured as a reporting tool, and
wherein the reporting tool is configured to display the results in a digitized chart or a similar diagram reporting the results for i) any one or more of the participants or ii) the aggregate of all the participants.

3. The apparatus of claim 1,
wherein the solicitation module is configured to present a first user interface including a digitized chart that has a set of at least 5 words conveying the perceptions and feelings along with any of a numeric indicator, a sliding scale, or a color to indicate an intensity for a selectable perception or feeling that a first participant is experiencing at a first discrete point during the study.

4. The apparatus of claim 1,
wherein the solicitation module is resident in a client device and is configured to cooperate with one or more servers or other computing devices to receive one or more of the user interfaces of the series of user interfaces.

5. The apparatus of claim 1,
wherein the study is a usability testing study for consumer behavior or market research; a diary study for a medical context or a therapy context in which the perception and feeling tool is configured to record participants' emotions throughout the day; or a combination thereof.

6. The apparatus of claim 1,
wherein the collection module is further configured to aggregate participants' perceptions and feelings for all of the participants in the study,
wherein the perception and feeling tool includes the collection module configured to collect the raw data, and
wherein the raw data is from participants selecting colors in matrices presented in the user interfaces, numeric values in the matrices, on-screen buttons corresponding to certain perceptions and feeling in the series of user interfaces, intensities for the certain perceptions and feelings, or a combination thereof.

7. The apparatus of claim 6,
wherein the colors and the numeric values correspond to a visual representation, a quantifiable representation, or a visual and quantifiable representation of the participants' perceptions and feelings.

8. The apparatus of claim 1,
wherein the collection module is configured to format and store 1) the raw data and 2) results from application of the one or more algorithms to quantify the perceptions and feelings from the participants in an exportable format.

9. The apparatus of claim 1,
wherein the perception and feeling tool is further configured to allow participants to express at least two perceptions and feelings at each of the multiple discreet points during the study in order to track primary and secondary perceptions and feelings of each participant throughout the study, and
wherein the perception and feeling tool is further configured to allow participants to express emotional intensities for the at least two perceptions and feelings at each of the multiple discreet points during the study.

10. The apparatus of claim 9,
wherein the one or more analytical modules are further configured to determine
a primary emotion score (“PES”) for each primary perception and feeling and its emotional intensity,
a secondary emotion score (“SES”) for each secondary perception and feeling and its emotional intensity, and
a holistic emotions quotient for the PES and SES weighted in accordance with the emotional intensity of the PES and the emotional intensity of the SES.

11. A non-transitory machine-readable medium configured to store instructions that when executed by one or more processors on a device, causes the device to perform the following operations, comprising:
providing a perception and feeling tool having multiple modules configured to present a series of user interfaces for
allowing participants to express perceptions and feelings at multiple discreet points during a study in order to track the perceptions and feelings of each participant throughout the study,
recording the participants' perceptions and feelings at the multiple discreet points during the study as collected data, and
displaying results for
i) any one or more of the participants as well as
ii) an aggregate of all the participants for the perceptions and the feelings at the multiple discreet points during the study to visually see the participants' perceptions and feelings at the multiple discreet points during the study;
collecting raw data including the participants' perceptions and feelings from the user interfaces with a collection module configured for the collecting;
applying analytics by one or more analytical modules to the raw data collected by the collection module in order to apply any of a linear algorithm, a weighted algorithm, or a combination of the linear algorithm and the weighted algorithm for determining any of
1) how the participants were feeling at the multiple discreet points during the study,
2) what the participants were perceiving at the multiple discreet points during the study, or
3) any combination of 1) and 2); and
soliciting each participant of the study using a solicitation module configured for the soliciting, presenting the series of the user interfaces to the participants in the study, and allowing the participants to express the perceptions and feelings at the multiple discreet points during the study,
wherein one of more modules of the perception and feeling tool are configured to cooperate with one or more processors on a computing device to execute instructions for any software portions of the one or more modules.

12. The machine-readable medium of claim 11, further comprising
displaying the results in a digitized chart or a similar diagram and reporting the results for i) the any one or more of the participants or ii) the aggregate of all the participants,
wherein the perception and feeling tool is further configured as a reporting tool configured for the displaying and reporting.

13. The machine-readable medium of claim 11, further comprising
presenting with the solicitation module a first user interface including a digitized chart that has a set of at least 5 words conveying the perceptions and feelings along with any of a numeric indicator, a sliding scale, or a color to indicate an intensity for a selectable perception or feeling that a first participant is experiencing at a first discrete point during the study.

14. The machine-readable medium of claim 11, further comprising
receiving by the solicitation module one or more of the user interfaces of the series of user interfaces,
wherein the solicitation module is resident in a client device and is configured to cooperate with one or more servers or other computing devices for the receiving.

15. The machine-readable medium of claim 11, further comprising
aggregating participants' perceptions and feelings for all of the participants in the study, wherein the collection module is configured for the aggregating.

16. The machine-readable medium of claim 15, further comprising
presenting the user interfaces and collecting the raw data with the collection module,
wherein the perception and feeling tool includes the collection module configured for the collecting, and
wherein the raw data is from participants selecting colors in matrices presented in the user interfaces, numeric values in the matrices, on-screen buttons corresponding to certain perceptions and feeling in the series of user interfaces, intensities for the certain perceptions and feelings, pictures, photos, videos, sounds, music, or a combination thereof.

17. The machine-readable medium of claim 16,
wherein the colors and the numeric values correspond to a visual representation, a quantifiable representation, or a visual and quantifiable representation of the participants' perceptions and feelings.

18. The machine-readable medium of claim 11, further comprising
formatting and storing 1) the raw data and 2) results from application of the one or more algorithms to quantify the perceptions and feelings from the participants in an exportable format,
wherein the collection module is configured for the formatting and storing.

19. The machine-readable medium of claim 11, further comprising
allowing participants through the perception and feeling tool to express at least two perceptions and feelings at each of the multiple discreet points during the study in order to track primary and secondary perceptions and feelings of each participant throughout the study, and
allowing participants through the perception and feeling tool to express emotional intensities for the at least two perceptions and feelings at each of the multiple discreet points during the study.

20. The machine-readable medium of claim 19, further comprising
determining with the one or more analytical modules
a primary emotion score (“PES”) for each primary perception and feeling and its emotional intensity,
a secondary emotion score (“SES”) for each secondary perception and feeling and its emotional intensity, and
a holistic emotions quotient for the PES and SES weighted in accordance with the emotional intensity of the PES and the emotional intensity of the SES.
